(19) United States
(12) Patent Application Publication
(10) Pub. No.: US 2024/0202463 A1
(43) Pub. Date: Jun. 20, 2024

(54) SYSTEMS AND METHODS FOR ASSESSING DYNAMIC ERGONOMIC RISK

(71) Applicant: Dassault Systemes Americas Corp., Waltham, MA (US)

(72) Inventors: Farhad Mazareinezhad, Montreal (CA); David Brouillette, Saint-Lambert (CA); Julie Charland, Montreal (CA); Daniel Imbeau, Montreal (CA); Firdaous Sekkay, Blanville (CA)

(21) Appl. No.: 18/390,174

(22) Filed: Dec. 20, 2023

Related U.S. Application Data
(60) Provisional application No. 63/476,182, filed on Dec. 20, 2022.

(51) Int. Cl. G06F 40/40; G06F 11/36

(52) U.S. Cl. CPC G06F 40/40; G06F 11/3612

(57) ABSTRACT

Embodiments provide functionality to assess dynamic ergonomic risk. One such example embodiment receives process planning data for an operator performing a task. Based on the received process planning data, parameters for a time analysis are defined and a time analysis of the operator performing the task is performed using the defined parameters. In turn, static ergonomic risk is determined based on the received process planning data. Then, an indication of dynamic ergonomic risk is provided based on (i) results of performing the time analysis and (ii) the determined static ergonomic risk.

### RELATED APPLICATION

This application claims the benefit of U.S. Provisional Application No. 63/476,182, filed on Dec. 20, 2022.

The entire teachings of the above application are incorporated herein by reference.

### BACKGROUND

A number of existing product and simulation systems are offered on the market for the design and simulation of objects, e.g., humans, parts, and assemblies of parts, and actions, e.g., tasks, associated with objects. Such systems typically employ computer aided design (CAD) and/or computer aided engineering (CAE) programs. These systems allow a user to construct, manipulate, and simulate complex three-dimensional (3D) models of objects or assemblies of objects. These CAD and CAE systems, thus, provide a representation of modeled objects using edges, lines, faces, polygons, or closed volumes. Lines, edges, faces, polygons, and closed volumes may be represented in various manners, e.g., non-uniform rational basis-splines (NURBS).

CAD systems manage parts or assemblies of parts of modeled objects, which are mainly specifications of geometry. In particular, CAD files contain specifications, from which geometry is generated. From geometry, a representation is generated. Specifications, geometries, and representations may be stored in a single CAD file or multiple CAD files. CAD systems include graphic tools for representing the modeled objects to designers; these tools are dedicated to the display of complex objects. For example, an assembly may contain thousands of parts. A CAD system can be used to manage models of objects, which are stored in electronic files.

CAD and CAE systems use of a variety of CAD and CAE models to represent objects. Such a model may be programmed so that the model has the properties (e.g., physical, material, or other physics based) of the underlying real-world object or objects that the model represents. Moreover, CAD/CAE models may be used to perform simulations of the real-world objects/environments that the models represent.

### SUMMARY

Simulating an operator, e.g., a human (which can be represented by a digital human model (DHM)), in an environment is a common simulation task implemented and performed by CAD and CAE systems. Here, an operator refers to an entity that can observe and act upon an environment, e.g., a human, an animal, or a robot, amongst other examples. Computer-based operator simulations can be used to automatically predict the behavior of an operator in an environment when performing a task with one or more objects, e.g., target objects. To illustrate one such example, these simulations can determine the position and orientation of a human when assembling a car in a factory. The results of the simulations can, in turn, be used to improve the real-world physical environment. For example, simulation results may indicate that ergonomics or manufacturing efficiency can be improved by relocating objects in the real-world environment.

Existing simulation methods, e.g., for workplace design, focus on either time analysis or ergonomic analysis. This is both inefficient and cumbersome. As such, functionality is needed that considers both time and ergonomics. Embodiments provide such functionality. In this way, embodiments provide functionality for assessing dynamic ergonomic risk. In other words, embodiments, provide an evaluation of ergonomics while performing a task where the ergonomics evaluation considers the time it takes to perform the task. This provides a significant improvement over existing methods because the comprehensive evaluation of ergonomics hinges on the simultaneous inclusion of time analysis.

An example embodiment is directed to a computer-implemented method of assessing dynamic ergonomic risk. Such a method receives, in memory of a processor (implementing the method), process planning data for an operator performing a task. To continue, parameters for a time analysis are defined based on the received process planning data, and a time analysis of the operator performing the task is carried out using the defined parameters. Next, such a method determines a static ergonomic risk based on the received process planning data. In turn, an indication of dynamic ergonomic risk is output based on (i) the results of performing the time analysis and (ii) the determined static ergonomic risk.

In an embodiment, the received process planning data includes a natural language statement. According to one such embodiment, defining the parameters comprises performing natural language processing on the statement to extract an indicator of a movement type. In turn, a category of movement is defined based on the indicator of a movement type. Then, based on the defined category, the parameters (i.e., variables in accordance with a predetermined motion time system (PMTS) model indicating a sequence of sub-activities (i.e., actions, events, etc.) to perform the task) for the time analysis are identified and a value of at least one parameter is set based on the received process planning data. In an embodiment, the parameters form a sequence model that is determined based on the types of motions. The sequence model includes a series of letters organized in a logical sequence. The sequence model defines the events or actions that take place in a prescribed order to perform a task, e.g., moving an object from one location to another. Yet another embodiment defines the parameters by translating an element of the natural language statement into a parameter definition.

According to another embodiment, the received process planning data includes at least one of: (i) the physical characteristics of a workstation in a certain real-world environment at which the task is performed, (ii) the physical characteristics of the operator, and (iii) characteristics of the task.

According to another aspect, receiving the process planning data comprises receiving a measurement from a sensor in a certain real-world environment in which the task is performed.

Embodiments may further include, e.g., prior to defining the parameters, identifying the parameters by searching a look-up table based on an indication of the task in the received data, wherein the look-up table indicates the parameters as a function of the task.

In an embodiment, the parameters are variables in accordance with a PMTS model (i.e., sequence model) where the variables indicate a sequence of sub-activities to perform a task. According to one such embodiment, the parameters are one of: Maynard Operation Sequence Technique (MOST) parameters, Methods-Time Measurement (MTM) parameters, Modular Arrangement of Predetermined Time Standards (MODAPTS) parameters, and Work-Factor (WF) parameters.

According to another embodiment, defining the parameters includes automatically defining a first subset of the parameters based on the received process planning data and defining a second subset of the parameters responsive to user input. In an embodiment, automatically defining the first subset of parameters includes (i) using the received process planning data to perform a computer-based simulation of a digital human model performing the task and (ii) defining at least one parameter, from the first subset of parameters, based on results of performing the computer-based simulation. According to another example embodiment, automatically defining the first subset of parameters comprises at least one of: (a) defining a posture parameter based on body position indications from the received process planning data and (b) defining a distance parameter based on an indication in the received process planning data of a start point and end point of the task. In yet another example embodiment, defining a second subset of the parameters responsive to user input comprises: based on the received process planning data, identifying a user prompt; providing the user prompt to a user; and receiving the user input responsive to providing the user prompt.

In embodiments, the indication of the dynamic ergonomic risk includes at least one of: a risk type, a risk location, a risk level, a suggestion to lower risk, and time to perform the task. Further, in an example embodiment where the indication of the dynamic ergonomic risk includes the suggestion, such an embodiment may determine the suggestion by searching a mapping between risk types, risk locations, and suggestions, wherein the determined suggestion is mapped to a given risk type and a given risk location of the dynamic ergonomic risk. Embodiments may further include implementing the suggestion in a certain real-world environment.

Another embodiment is directed to a system for assessing dynamic ergonomic risk, e.g., evaluating the probability that performing a task will cause harm to a worker in a workplace. According to an embodiment, the system includes a processor and a memory with computer code instructions stored thereon. In such an embodiment, the processor and the memory, with the computer code instructions, are configured to cause the system to implement any embodiments or combination of embodiments described herein.

Yet another embodiment is directed to a cloud computing implementation for assessing dynamic ergonomic risk. Such an embodiment is directed to a computer program product executed by a server in communication across a network with one or more clients. The computer program product comprises program instructions which, when executed by a processor, causes the processor to implement any embodiments or combination of embodiments described herein.

It is noted that embodiments of the method, system, and computer program product may be configured to implement any embodiments, or combination of embodiments, described herein.

### BRIEF DESCRIPTION OF THE DRAWINGS

The foregoing will be apparent from the following more particular description of example embodiments, as illustrated in the accompanying drawings in which like reference characters refer to the same parts throughout the different views. The drawings are not necessarily to scale, emphasis instead being placed upon illustrating embodiments.

FIG. 1 is a flowchart of a method for assessing dynamic ergonomic risk according to an embodiment.

FIG. 2 depicts a graphical user interface (GUI) that may be used to input data in an embodiment.

FIGS. 3-6 are graph diagrams illustrating the contribution of data and user inputs to influencing variables, i.e., parameters.

FIGS. 7A-E are interfaces showing data input tools, steps of a task, and results for evaluating, using an embodiment, dynamic ergonomic risk of performing the task.

FIGS. 8A-E are interfaces showing data input tools, steps of a task, and results for evaluating, using an embodiment, dynamic ergonomic risk of performing the task.

FIG. 9 is a simplified diagram of a computer system for assessing dynamic ergonomic risk according to an embodiment.

FIG. 10 is a simplified diagram of a computer network environment in which embodiments of the present invention may be implemented.

### DETAILED DESCRIPTION

A description of example embodiments follows.

Work-related musculoskeletal disorders (MSDs) are injuries that affect the human body's movement and musculoskeletal systems, including the muscles, tendons, ligaments, nerves, and other soft tissues (Hales & Bernard, 1996). These disorders can result from various risk factors, including poor posture, repetitive motions, and forceful movements. MSDs are significant public health problems among the leading causes of disability and lost productivity worldwide (Bevan, 2015).

The economic cost of MSDs is considerable. It is estimated that work-related injuries cost nations 1.2-6.2% of their gross domestic product, comparable to cancer costs (Leigh, 2011). According to a European Agency for Safety and Health at Work report, MSDs account for up to 50% of all work-related illnesses in the European Union and cost an estimated €240 billion per year (Bevan, 2015). In the United States, MSDs account for nearly one-third of all workplace injuries and illnesses, costing employers an estimated $50 billion per year in direct and indirect costs (Silverstein et al., 2002).

Ergonomics is the scientific discipline concerned with designing products, processes, and systems to optimize human well-being and overall system performance. It aims to ensure that workspaces, tools, and equipment are designed to fit the workers' physical and cognitive capabilities to prevent MSDs and increase productivity. By using ergonomics methods like biomechanical analysis, observation, and self-report surveys, it's possible to identify and mitigate risk factors linked to musculoskeletal disorders (MSDs) (Bernard, 1997).

Boosting productivity while upholding safety is paramount for any company's success. Enhancing productivity fuels organizational growth and strengthens competitive advantage. Accurately estimating the time required for various operations is a key approach to monitoring productivity. By pinpointing time requirements, companies can streamline processes, optimize efficiency, and ultimately elevate overall productivity levels (Wells et al., 2007).

Predetermined Motion Time Systems (PMTSs) have been instrumental for many years in estimating the time required for human work sequences, i.e., sequences of sub-activities to perform tasks. Using a PMTS involves breaking down a task into its constituent motions and assigning predefined time values to each of these motions. The primary purpose of PMTSs is to determine the amount of time a worker will need to produce a specific product unit in a simulated future assembly line design scenario. This determination of time holds crucial significance in the computation of the anticipated cost of the product (Zandin, 2002).

PMTSs encompass several categories, such as MTM, MOST, MODAPTS, and Work Factor. Each PMTS has its own unique attributes, i.e., parameters, and applications, making each PMTS a valuable tool across a range of industrial and manufacturing settings.

The design of human work processes is a critical task in industrial companies, with productivity and ergonomics being crucial performance indicators. To assess and enhance these indicators, professionals utilize a variety of methods for analyzing and designing work processes. However, most of these methods focus on either productivity or ergonomics considerations separately, rather than addressing both simultaneously. Additionally, the existing methods often require substantial manual effort in terms of data collection and interpretation when performing time and ergonomics analyses (Kuhlang et al., 2023).

The diverse nature of time and ergonomics analyses necessitates that two groups of people with different expertise, technical language, and perspectives analyze the same design at different times. This makes the process cumbersome and inefficient (Wells et al., 2007). Thus, it is becoming increasingly apparent that effective workplace design requires an integrated approach that encompasses time estimations and ergonomics analysis. This eliminates the need for separate procedures for describing and evaluating work times, and ergonomics aspects, such as postures and force exertions (Laring et al., 2005).

Digital Human Modeling systems (DHMs) are software solutions that allow users to create virtual models of humans and simulate their interactions with the environment. DHMs have gained increasing popularity in recent years as tools for simulating and analyzing the design of workplaces. DHMs can facilitate ergonomics analysis by integrating various ergonomics methods to evaluate workstations, allowing for the assessment of physical demands on workers and the optimization of work processes before the physical structure is implemented. This, in turn, leads to improved productivity in the design process (Schaub et al., 2012), ultimately reducing the costs and time associated with physical prototyping and testing (De Magistris et al., 2015; Kazmierczak et al., 2007; Falck et al., 2010; Laring et al., 2005).

Moreover, DHM systems can similarly be used to evaluate existing environments, e.g., a manufacturing line, and determine ergonomic improvements to the existing environments so as to improve worker health.

One of the primary challenges to the successful application of a DHM is the lack of integration between time estimation and ergonomics analyses for 3D-designed human work (Kuhlang et al., 2023). Ergonomics analysis ensures the safety and productivity of the designed tasks, but feasible times must be assigned to digitally recorded work sequences to achieve design productivity, e.g., the time it takes to perform a task. Additionally, some of the more advanced ergonomics assessment methods, such as Occupational Repetitive Actions (OCRA), require determining the duration of operations. These assessment tools can estimate the MSD risk associated with a worker's movements and postures over a work shift (Colombini, 2002).

Identifying potential ergonomics related risks and implementing design interventions to reduce fatigue and MSD risks can enhance worker safety and health. Thus, the lack of integration of time estimation in a DHM can limit its effectiveness in analyzing the ergonomics related risks associated with a sequence of events (or sub-activities) that unfolds in time, as it fails to provide the necessary temporal context required for proper risk assessment. This limitation can restrict the modeling, designing, and optimization of human-centric systems and products. Furthermore, it can increase the complexity and cost of the assessment process, as time and ergonomics analysis need to be performed separately with current approaches.

Efforts have been made to integrate time and ergonomics analysis in approaches such as ErgoSAM (Laring et al., 2005), Ergo-UAS (Vitello et al., 2012), and MTM-HWD (Faber, 2019). However, these existing methods are paper-based and lack integration into automated software solutions, making them time-consuming and challenging to use together with complex in-house integrated software systems.

Several DHM systems, including Jack, RAMSIS, Pro/ENGINEER, and HumanBuilder, can perform ergonomics analysis of a 3D simulated work sequence. These systems allow the creation of realistic virtual human models, simulate human-environment interactions, and provide a comprehensive approach to ergonomics evaluation (Agostinelli et al., 2021; Miehling et al., 2013). Jack by Siemens is a DHM system for ergonomics analysis that enables integrated ergonomics and time analysis using MTM-1 standards and simulation techniques (Grandi et al., 2021).

Despite these efforts, there remains a notable deficiency in the availability of virtual ergonomics tools adept at seamlessly integrating predetermined motion time systems (PMTS) with ergonomics analysis within a DHM environment. This insufficiency presents significant challenges in the successful implementation and utilization of DHM tools (Kuhlang et al., 2023). Further research is needed to clearly define the boundaries and research problems and address the gaps in DHM and PMTS integration.

Embodiments provide such functionality. For instance, an embodiment is directed to a comprehensive framework for conducting time analysis using the MOST (Maynard Operation Sequence Technique) predetermined motion time system within 3D environments of a DHM system. Such an embodiment facilitates automated time analyses on 3D-designed operations of workstations, even by users lacking prior knowledge in the field, resulting in a streamlined and accelerated design process, ultimately leading to increased workplace productivity and safety.

Time Estimation with MOST

The Maynard Operation Sequence Technique (MOST) serves as a widely adopted time system in various industrial domains. It offers a structured approach for describing and analyzing the diverse actions performed by workers during task execution. These actions encompass a wide range of activities typical of handling objects, such as grasping them, moving them over distances, placing them at precise locations, etc., that is, activities that are typically found in manual assembly tasks. MOST employs data cards containing standardized codes that are used to describe the actions performed by a worker during manual work. The data cards also provide instructions for quantifying additional activities, like walking, machine usage, and tool use that can be part of a work content. To estimate the total time required for a given work content, one simply aggregates the predetermined time values associated with each of the MOST codes that were used to describe the work content, as outlined by Zandin in 2002. The analysis process thus requires, specifying the work content, assigning MOST codes that best describe the work content, and then summing the time values associated with each code. It is noted that while embodiments are described as utilizing the MOST PMTS, embodiments are not limited to utilizing MOST, and any PMTS known to those of skill in the art may be utilized.

Table 1 shows the three main motions in MOST, along with the corresponding sequence model and parameters (Zandin, 2002). The sequence model specifies the order in which the different parts of motion are performed (e.g., the motion of the hand between two points, to reach an object, grasp it, and then place it at a precise location). The parameters are characteristics of the motion that impact the time it takes to perform it. For instance, if the distance traveled by the hand is large (Action distance), then the motion is expected to take longer and hence a higher time value will be associated with it. To be able to assign time values to all parts of a motion sequence model, one has to characterize all of the parameters, that is, measuring the Action distance in cm in the preceding example. This detailed parameter description is typically done manually while observing a worker performing a work content, and thus it is very time-consuming.

TABLE 1
Sequence models for motions in MOST (adapted from Zandin, 2002).
Motion Sequences in MOST

| Activity | Sequence Model | Parameter |
|---|---|---|
| General Move | ABGABPAA | A-Action distance |
| | | B-body motion |
| | | G-gain control |
| | | P-placement |
| Controlled Move | ABGMXIA | M-move controlled |
| | | X-process time |
| | | I-alignment |
| Tool Use | ABGABP*ABPA | F/L-fasten/loosen |
| | | C-cut |
| | | S-surface treat |
| | | M-measure |
| | | R-record |
| | | T-think |

Table 2 shows the General move data card, which can help understand how the motion characteristics described by the parameters influence the time it takes to accomplish the motion. For example, the Action distance has up to 6 levels. The higher the level, the higher the index, and the higher the time it takes to travel over the Action distance. In the same fashion, the Placement parameter has 4 levels. At the higher level, if the Placement of the object in its final location requires precision because of a tight fit for instance, then it also requires more time to be performed than at the lower level (pick up or toss). The presence of two identical index columns in Table 2 primarily facilitates ease of use and clarity in recording and analyzing tasks. To utilize the Table 2, e.g., to perform a time analysis in an embodiment, the value for each parameter is identified, e.g., automatically from memory storing the left or right index column of the data card. A higher index value correlates to a longer duration required to execute an action. The basic unit of time measurement in MOST is TMU (Time Measurement Unit). To calculate the time needed for an activity, an embodiment sums up the index values within the sequence model (i.e., the parameters indicating the sub-activities to perform the task). This sum is then multiplied by 10 to convert the sum into TMU, where each TMU equals 0.036 seconds.

TABLE 2
General Move Data Card (adapted from Zandin, 2002)

| BasicMOST System | | | General Move | ABGABPA | | |
|---|---|---|---|---|---|---|
| Index | A | | B | G | P | Index |
| ×10 | Action distance | | Body motion | Gain control | Placement | ×10 |
| 0 | <=2 Inches (5 cm) | | | | Pick up, Toss | 0 |
| 1 | Within reach distance | | | Light Object/Light | Lay aside, Loose Fit | 1 |
| | | | | Object Simo | | |
| 3 | 1-2 | steps | Sit, Stand, Bend and Arise 50% | Light Object non- | Loose fit | 3 |
| | | | occurrence | Simo, Heavy/Bulky, | blind/Obstructed, | |
| | | | | Blind/Obstructed- | Adjustment, Light | |
| | | | | Disengage, | pressure, Double | |
| | | | | interlocked, Collect | placement | |
| 6 | 3-4 | steps | Bend and Arise | | Care/Precision, Heavy | 6 |
| | | | | | Pressure, | |
| | | | | | Blind/Obstructed, | |
| | | | | | Intermediate Moves | |
| 10 | 5-7 | steps | Sit& stand with adjustment | | | 10 |
| 16 | 8-10 | steps | stand and bend, Bend and sit, | | | 16 |

climb on/off, Through Door

The MOST codes can be generated once index values are assigned to the parameters based on the characteristics of a motion that influence or impact the time it takes to perform that motion. To estimate the time required for a 3D-designed task in a DHM system, embodiments utilize several sources of information. A significant portion of the MOST building block parameters can be derived from information available in a DHM simulation, such as the inputs used to create a human model or the CAD information accessible within 3D environments. However, some physical data (such as information regarding complex postures like interlocked grasps in the General move category) and mental data (such as information regarding reading or thinking in the Tool use category) is typically not available in a DHM system and, thus, embodiments, cannot identify and extract all of the task characteristics to define MOST parameters in every simulation scenario.

Embodiments implement techniques to overcome the missing data in these scenarios, e.g., when data needed to define a MOST code is not available or derivable from data in a DHM system. In some embodiments, assumptions are utilized to simplify the extraction of data from 3D models. Additionally, embodiments can obtain supplementary information from DHM users. In this way, embodiments can determine the information to estimate the time for 3D-designed motions.

### Application of MOST Predetermined Motion Time System in DHM Systems

In a real-world work setting, a time analyst typically conducts direct observations of a worker's motions during task performance. The analyst records the fundamental aspects of the worker's movements and subsequently maps these to the relevant MOST codes. Temporal values are assigned based on established empirical data.

However, in the context of a 3D DHM environment, where a live worker is absent, traditional observation-based methodologies are inapplicable. Instead, to utilize MOST with a DHM system, the data for temporal analysis must be sourced from available resources within the 3D-designed workstation. These available resources include information such as the spatial characteristics and dimensions of manipulated objects, as well as the postures and movements of a simulated worker (DHM), within CAD models.

To apply MOST in a DHM environment, adjustments to MOST data cards are needed to accommodate the unique characteristics of the simulated workspace and the three-dimensional context of the DHM system. This can include expanding or adjusting the basic elements of the motion sequences and motion characteristics that are described in MOST data cards to reflect the unique aspects of the simulated work/environment and adding new elements to capture information that is relevant specifically in simulated environments. The time values assigned to each element may also be fine-tuned to align with the specific details of the simulated task.

Currently, DHM systems are capable of analyzing static postures associated with using a tool in a given posture. However, in order to analyze a work sequence or put a time estimate on a work sequence, an embodiment first obtains data indicating the work sequence (i.e., describing the work sequence). Users typically want to use natural/common language terms to describe different actions/activities workers perform in a work sequence. However, there exists a wide range of terminology used to describe work and this wide range of terminology may not correspond directly to the standardized terminology used in PMTSs, e.g., MOST. Therefore, an embodiment translates a user's descriptions of work sequences, expressed in common language terms, into corresponding sequences using PMTS, e.g., MOST, terminology. These modifications and translations enable a PMTS to effectively analyze each activity within work sequences in DHM environments.

### Example Solutions

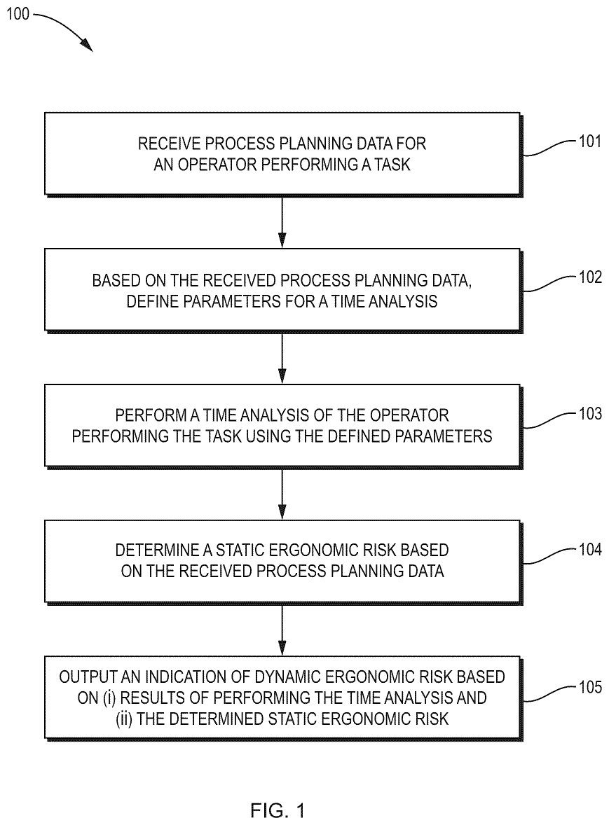

FIG. 1 is a flowchart of a method 100 for assessing dynamic ergonomic risk according to an embodiment. The method 100 is computer-implemented and may be performed using any combination of hardware and software as is known in the art. For example, the method 100 may be implemented via one or more processors with associated memory storing computer code that causes the processor to implement steps 101-105 of the method 100.

The method 100 begins at step 101 by receiving, in memory of a processor, process planning data for an operator performing a task. Next, at step 102, parameters for a time analysis are defined based on the received process planning data and, at step 103, a time analysis of the operator performing the task is performed using the defined parameters. To continue, at step 104, a static ergonomic risk is determined based on the received process planning data. In turn, at step 105, an indication of dynamic ergonomic risk is output based on (i) results of performing the time analysis and (ii) the determined static ergonomic risk.

The method 100 is computer implemented and, as such, the process planning data may be received at step 101 from any location, memory, or data storage, that can be communicatively coupled to a computing device implementing the method 100. In embodiments, the received process planning data may include any data known to those of skill in the art that relates to the task being assessed. For instance, in an embodiment of the method 100, the process planning data received at step 101 includes at least one of: the physical characteristics of a workstation in a certain real-world environment at which the task is performed, physical characteristics of the operator, and characteristics of the task. Amongst other examples, characteristics of objects and/or tools that are utilized in performing, or associated with, the task, may be received at step 101.

Further, embodiments of the method 100 may be utilized to assess a real-world environment, e.g., a workstation at a factory, and results can be utilized to modify the real-world environment, e.g., to improve ergonomics. In such an embodiment, receiving the process planning data at step 101 can include receiving a measurement from a sensor in a certain real-world environment in which the task is performed. Amongst other examples, the measurements can include dimensions of a workstation, weights, and dimensions of objects, and locations of objects.

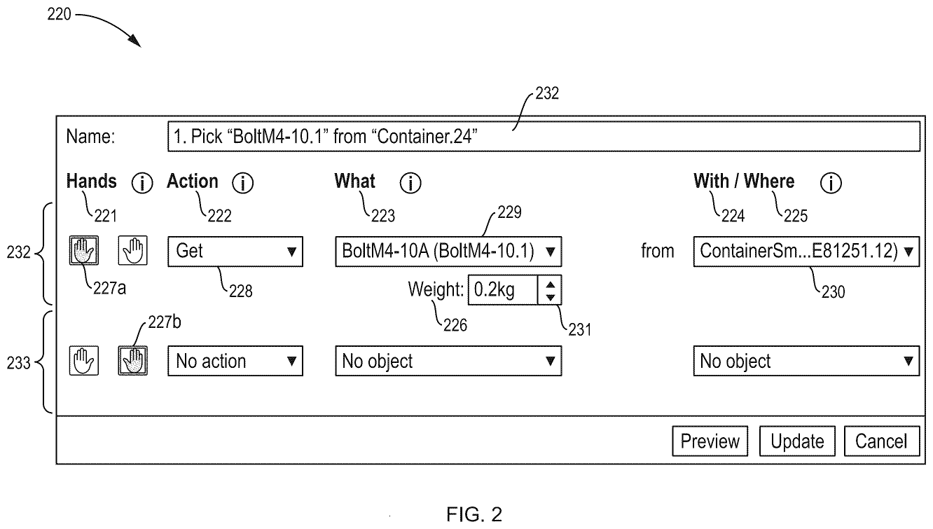

In yet another embodiment, the process planning data received at step 101 includes a natural language statement. According to an embodiment, the natural language statement is received responsive to user input provided via a graphical interface, such as the interface 220 described hereinbelow in relation to FIG. 2. In yet another embodiment, the natural language statement is obtained using functionality in U.S. Patent Publication No. 2023/0169225 A1.

In an embodiment where the process planning data includes a natural language statement, defining the parameters at step 102 includes, first, performing natural language processing on the statement to extract an indicator of a movement type. Examples of indicators of movement type include verbs or phrases that imply actions or movements, such as “get,” “move,” “grasp,” “align,” “fasten,” or “clean,” amongst other examples. These verbs or phrases serve as indicators within the natural language statement. Further, these terms typically align with movement types falling into motion categories such as “General Move,” “Controlled Move,” or “Tool Use” in MOST. To continue, such an embodiment defines a category of movement based on the indicator of a movement type and, based on the defined category, identifies the parameters for the time analysis. In turn, a value of at least one parameter is set based on the received process planning data. To illustrate such functionality, consider an example embodiment where, for instance, the natural language statement contains the term ‘Fasten.’ Such an embodiment can define the corresponding MOST motion category which is “Tool use” and, consequently, such an embodiment defines the sequence model for this movement type and identifies the temporal index values for the parameters within this sequence model accordingly. In yet another embodiment of the method 100 where the process planning data includes a natural language statement, defining the parameters comprises translating an element of the natural language statement to a parameter definition.

According to an embodiment, the parameters indicate the sequence of sub-activities to perform the task. In an embodiment, the parameters indicating the sequence of sub-activities may be parameters from an existing time analysis model, e.g., the sequence of a PMTS model. In other words, in such an embodiment, the parameters are variables in accordance with a PMTS model where the variables indicate a sequence of sub-activities to perform a task. Amongst other examples, in an embodiment, the parameters are one of: Maynard Operation Sequence Technique (MOST) parameters, Methods-Time Measurement (MTM) parameters, (Modular Arrangement of Predetermined Time Standards (MODAPTS) parameters, and Work-Factor (WF) parameters.

Before defining the parameters at step 102, embodiments of the method 100 may first identify the parameters to be defined. In one such embodiment, the parameters are identified by searching a look-up table, e.g., Table 1, based on an indication of the task in the received data. In such an example embodiment, the look-up table indicates the parameters as a function of the task. In an embodiment, worker-task actions (as indicated in the process planning data received at step 101) are used to define a motion category and a sequence model to perform the task, and then, from the sequence model, parameters (e.g., PMTS codes) are defined. To define the parameter values (e.g., codes values) at step 102, an embodiment investigates objects, tools, distances, posture, etc. Such functionality may include analyzing and/or processing data received at step 101, and defining the parameters at step 102 based on the results of said analysis and processing.

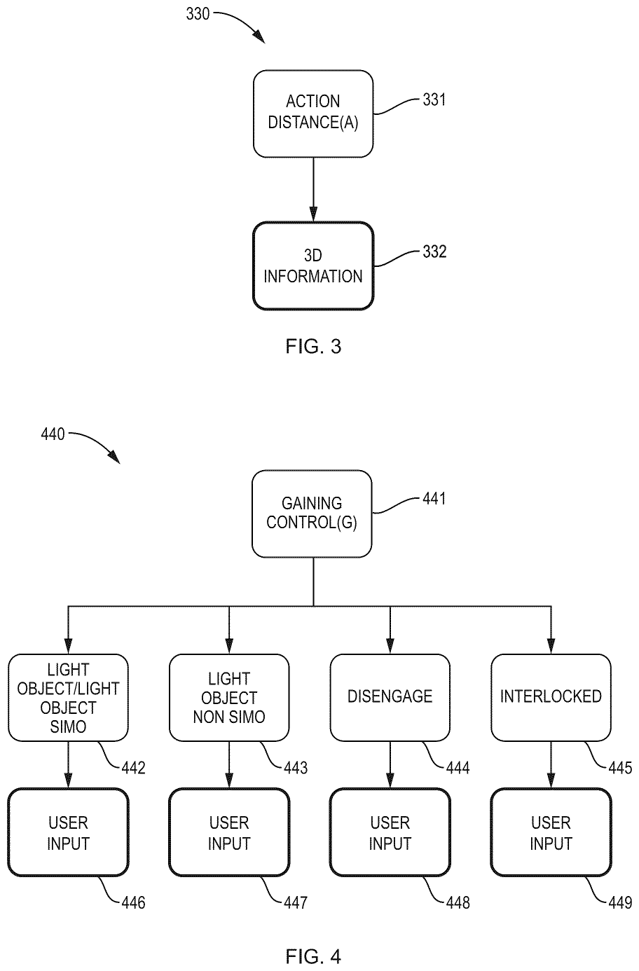

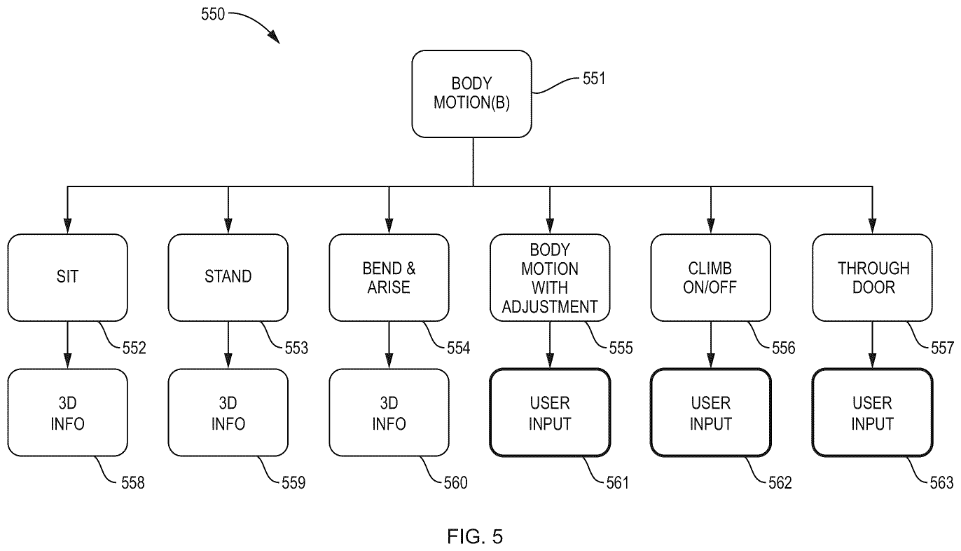

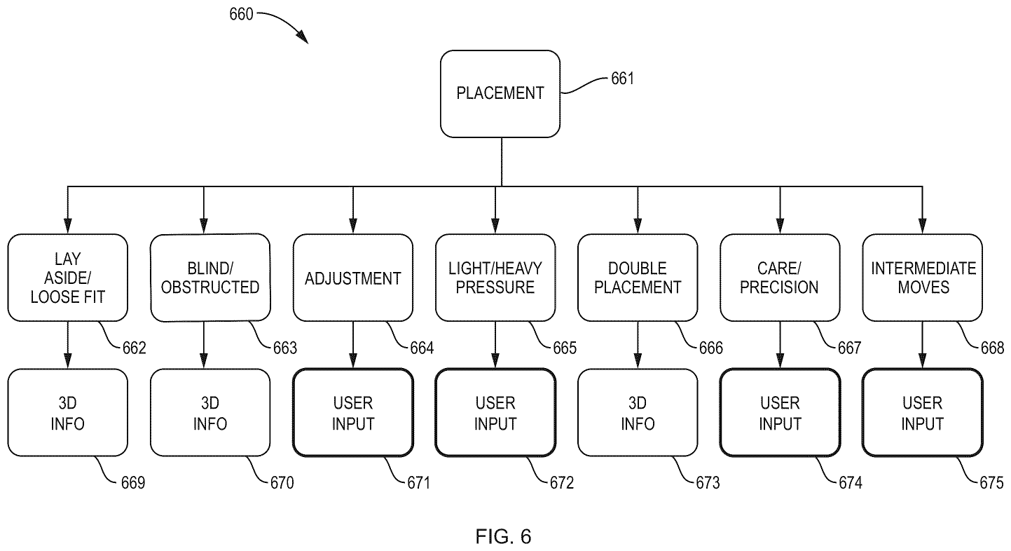

In another embodiment of the method 100, defining the parameters at step 102 includes automatically defining a first subset of the parameters based on the received process planning data and defining a second subset of the parameters responsive to user input. An embodiment of the method 100 utilizes the relationships shown in the graphs 330, 440, 550, and 660, described hereinbelow in relation to FIGS. 3-6, respectively, at step 102 to define the parameters. More specifically, such an embodiment can automatically define parameters and define parameters based on user input, in accordance with the graphs 330, 440, 550, and 660 described hereinbelow.

According to an embodiment, automatically defining the first subset of parameters comprises using the received process planning data to perform a computer-based simulation of a digital human model performing the task and, in turn, defining at least one parameter, from the first subset of parameters, based on results of performing the computer-based simulation. To illustrate, the received process planning data may be used in a DHM system with a 3D model (defined based on the process planning data) that includes a DHM and representations of tools and objects (amongst other examples) to determine properties of the environment being simulated. These properties, e.g., positions of the tools and a posture for the DHM, can be used to define parameters. In an example embodiment, the determined properties are used to calculate the distance between the DHM and a tool when performing a task. In such an embodiment, this distance can be used to define a parameter.

Further, embodiments of the method 100 may implement a variety of different techniques, alone or in combination, to automatically define parameters at step 102. For instance, embodiments may define a distance parameter based on an indication in the received process planning data of a start point and end point of the task and/or define a posture parameter based on body position indications from the received process planning data. In an embodiment, posture parameters include “Body Motion” which is a MOST parameter that encompasses vertical movements of the body or actions needed to address obstacles or limitations to body movement. According to an embodiment, defining the posture parameter using indications from the received process planning data includes providing the received process planning data to a Smart Posture Engine™ (SPE™) to determine a posture for the DHM. This determined posture is then utilized in such an embodiment the define the posture parameter.

In embodiments, automatically defining parameters can also include defining distance, defining body postures, and defining accuracies that are used for time estimations including the accuracies of grasping and placing an object and tools (Gain control and Placement parameters) that can be defined based on the dimensions of the objects or tools. To illustrate, consider an embodiment that is assessing the dynamic ergonomic risk of the action of grasping a cap and placing the cap on an assembly. In such an embodiment, several parameters can be automatically defined based on user inputs and the corresponding 3D model (e.g., through use of a Smart Posturing Engine™ (SPE™)). In such an illustrative embodiment, a user specifies inputs in a user panel, such as the interface 220 described herein. The inputs can include the action, specifics of ‘what’ and ‘where’, the active hands, the cap to be picked, and a target assembly for cap placement. In an embodiment, these selections are made from a list of available tools and objects. Subsequently, such an embodiment can automatically determine the following parameters: (1) Action distance: This parameter is automatically determined by the pre-defined layout, specifying distances between the assembly and the cap, the human model, and the cap, as well as the human model and the assembly; (2) Body motion: The embodiment automatically identifies the posture with the help of a SPE™, and a posture tracking system defines the corresponding body motion; (3) Gain control: Based on the dimension of the cap and defined thresholds, the embodiment defines this parameter (for instance, larger caps may require higher control for grasping, resulting in a higher index value for G); (4) Placement: The embodiment, utilizing an expanded action directory, determines the level of pressure needed for assembly and such an embodiment also assesses placement precision by analyzing the cap's dimensions and the cap's fit (play) on the assembly, if the play is more than a threshold, the embodiment can define approximate placement (lower index value), if the play is less than the threshold, the embodiment can define precise placement, leading to a higher index value.

To define parameters, e.g., the second subset of the parameters, responsive to user input, an embodiment identifies a user prompt based on the received process planning data and provides the user prompt to a user. In turn, the user input is received responsive to providing the user prompt. To illustrate, such an embodiment may analyze the process planning data and, therefrom, identify a parameter that cannot be defined using the process planning data. Such an embodiment will then prompt the user for the data that is needed to define the parameter.

After defining the parameters at step 102, the method 100, at step 103, performs a time analysis. Performing a time analysis at step 103 may include aggregating the time it takes to perform each operation of performing the task. To illustrate, consider an embodiment where the parameters defined at step 102 each correspond to an operation that make-up a sequence of sub-activities to perform the task. In such an embodiment, each parameter has an associated pre-defined time indicating how long each operation takes. Thus, in such an embodiment, performing the time analysis at step 103 includes aggregating each operation's pre-defined time to determine the total time it takes to perform the task.

In another embodiment, after defining the parameters at step 102, the method 100 proceeds to step 103 to complete the time analysis by calculating the total time. Performing time analysis at step 103 may include aggregating the time it takes to perform each sub-activity within the task. To illustrate, consider an embodiment where the parameters defined at step 102 correspond to individual sub-activities constituting a sequence to perform the task. In such an embodiment, each parameter has an associated pre-defined time indicating how long each sub-activity takes. Consequently, the time analysis at step 103 entails summing the pre-defined times for the sub-activities. In such an embodiment, this total is then multiplied by the activity frequency (which may be user defined) and converted into TMU (Time Measurement Unit) by multiplying it by 10. Lastly, the TMU total is converted into seconds by multiplying it by 0.036, thereby determining the overall time required to perform the entire task.

At step 104, a static ergonomic risk is determined based on the received process planning data. In embodiments of the method 100, the static ergonomic risk can be determined using the functionality described in U.S. Patent Publication No. 2023/0177228 and/or U.S. Patent Publication No. 2023/0177437. According to an embodiment, the static ergonomic risk is determined at step 104 using process planning data and/or data that can be generated/determined using the process planning data. An example embodiment utilizes manikin posture, object weight, task frequency, task time, motion speed (which can be based on user input indicating slow/no motion, evident movement, etc.), work hour per day (which can be based on user input indicating 1 hour or less, more than 1 hour up to 2 hours, more than 2 hours up to 8 hours). In absence of user inputs, an embodiment can use default values, such as a frequency of 2 actions per minute, a task time of 0.05 minutes, a speed of slow or no motion, a duration of more than 1 hour up to 2 work hours per day.

According to an embodiment, outputting an indication of dynamic ergonomic risk at step 105 includes outputting an indication of dynamic ergonomic risk based on (i) results of performing the time analysis and (ii) the determined static ergonomic risk. At step 105, an embodiment determines a dynamic risk that is a cumulative risk based on the time analysis (e.g., resulting in a determination of total time for performing the task) and the determined static risk, where determined static risk includes risk for each of multiple postures to perform the task. Such an embodiment determines and outputs an indication of the dynamic cumulative ergonomic risk. In such an embodiment, determining the static risk at step 104 includes determining a risk for each of multiple postures to perform the task. Further, at step 105, an embodiment determines (and outputs) an overall ergonomic score based on both the time analysis and postures for the entire cycle of actions to perform a task.

According to an embodiment, the indication of the dynamic ergonomic risk includes at least one of: a risk type, a risk location, a risk level, a suggestion to lower risk, and time to perform the task.

Embodiments of the method 100 may also perform real-world actions to improve efficiency and ergonomics, amongst other examples. For instance, in an embodiment where the indication of the dynamic ergonomic risk includes a suggestion, the method 100 may further include determining the suggestion by searching a mapping between risk types, risk locations, and suggestions. The determined suggestion is mapped to a given risk type and a given risk location of the dynamic ergonomic risk. In turn, such a method implements the suggestion (or causes the implementation of the suggestion, e.g., via providing the suggestion as output) in a certain real-world environment.

The description of a work sequence can play a vital role in understanding the actions and movements of a virtual mannequin in a DHM system. Natural language processing techniques are utilized in an embodiment of method 100 to extract relevant information from a task description provided by a user. For instance, extracted information may include the types of movements (e.g., reaching, grasping, lifting), the objects involved, and the sequence of sub-activities. Once an embodiment identifies relevant actions, the next step is to analyze the 3D data to determine the MOST parameters (Codes) and each parameter's temporal index values based on the available data in 3D environments. Such functionality may be performed at step 102 of the method 100.

It is noted that the work sequence description and the subsequent 3D data analysis are complementary methods for calculating motion times in DHM systems according to an embodiment. While the description provides valuable context and task-related information, the 3D data analysis allows for a more precise measurement of relevant parameters, such as the distances covered during actions.

### Information to Create Digital Human Model

The application of MOST in the realm of a DHM system according to an embodiment utilizes an assessment of DHM-related data to establish the fundamental elements of MOST, e.g., the parameters, and their determining factors. In general, a comprehensive set of data and parameters is utilized to simulate a human work process (task) in a DHM system where a human is represented by a mannequin in a 3D environment.

A component in an embodiment is user input, which serves as the descriptor for the work sequence, e.g., operations comprising a task. According to an embodiment, the input data encompasses contextual information, such as surrounding resources like objects and tools, as well as a phrase that describes the most likely action that the mannequin's posture partially simulates (action). A mannequin's fixed posture is often associated with force exertion events, such as lifting a component from a jig or applying force on a tool positioned on a component.

FIG. 2 illustrates an example interface 220 for providing input data. In particular, a user can use the interface 220 to indicate “hand” 221 (e.g., the hand(s) being utilized), “action” 222, “what” 223, “with” 224, “where” 225, and weight 226. “Hand” 221 specifies (using the selection buttons 227a-b) the actively engaged hand in the action 222 and outlines the role of the passive hand (left 227a or right 227b), which may assist or hold. In the interface 220, the row 232 indicates the role of the left hand 227a and the row 233 indicates the role of the right hand 227b. “Action 222” (indicated using dropdown 228) details the specific activities involved in the motion (i.e., task). “What” 223 (indicated using dropdown 229) identifies the object or tool subject to manipulation during the action 222. “With” 224 indicates any additional object or tool involved in the action, where applicable. It is noted that the example illustrated in the interface 220 does not involve “with” 224, but like other input data, the “with” data 224 can be provided using a dropdown. “Where” 225 (indicated via dropdown 230) describes the place where the action takes place and ends. Weight 226 (provided via selection box 231) quantifies the weight of the manipulated object or tool, when relevant. Using the interface 220 allows users to provide a significant portion of the foundational elements for time analysis.

In FIG. 2 the input parameters are illustrated in a simulation scenario where a bolt is retrieved from a container. This scenario delineates the active hand, specifies the type of bolt involved, and provides information regarding the bolt's weight. The natural language sentence 232 created is also illustrated in the interface 220.

According to an embodiment, the “Actions” or “Action verbs” 222 are selected via drop down 228 from a directory. In an embodiment, the “actions” 222 are a collection of predefined movements a DHM can perform in an environment being simulated. These actions 222 can range from basic movements, such as “Get,” “Place,” and “Move,” to more complex activities, such as “Screw,” “Operate,” and performing assembly tasks. However, according to an embodiment, this library is limited by a DHM's ability to create corresponding postures in a 3D environment, which restricts the model's range of movements.

To accurately represent human work processes within a DHM system, a substantial amount of information and parameters are needed, much like the data required for MOST analysis. This information encompasses details about the objects or tools involved in a task and precise descriptions of the actions that best represent the work process. In essence, much of the foundational information required for MOST (or other such PMTS) analysis is already embedded within the simulation.

In an embodiment, the DHM information is examined for the presence of each MOST parameter listed in Table 1. In such an embodiment, the initial focus is on defining General move parameters, such as Action distance, Body motion, Gain control, and Placement, which constitute fundamental components of each MOST code. Table 3 presents the parameters and their corresponding motion characteristics that influence the time required for motion execution, as outlined in Table 2, alongside their availability in a DHM system environment in which embodiments are implemented. Table 3 also provides a brief explanation of how these parameters can be defined in a DHM system implementing an embodiment.

TABLE 3
MOST Parameters for General Moves, Motion characteristics, And
the Availability of motion characteristics in a DHM System

| | | | The available | |
|---|---|---|---|---|
| | | Availability | 3D information/ | |
| MOST | Motion | in a 3D | Necessity of | |
| parameters | Characteristic | environment. | User inputs. | Explanation |
| Action | A1-A16 | Available | Automatic | To calculate the traveled distances in a |
| distance | | | determination | task, the starting and ending points of |
| (A) | | | based on the | action can be defined in the 3D |
| | | | coordinates of | environment. The distance formula can |
| | | | the 3D-designed | be applied to calculate the distance |
| | | | models. | traveled based on the coordination |
| | | | | system of a specific reference point |
| | | | | (Refer to “Action Distances” section for |
| | | | | more detail). |
| Body | Sit/Stand | Available | Automatic | A posture-tracking system determines |
| Motion | Bend and Arise | | determination | the joint angles of a mannequin in |
| (B) | 50% occurrence | | based on | different postures, and a decision system |
| | Bend and Arise | | designed | analyzes the angles based on defined |
| | Bend and sit/stand | | Postures. | thresholds and boundaries to label each |
| | and bend | | | posture with corresponding body motion |
| | | | | parameters (Refer to Body Motions |
| | | | | (Posture Definitions) section for more |
| | | | | detail). |
| | Sit or stand with | Not directly | User input. | The adjustment concept is too obscure to |
| | adjustments | recognizable | | describe in 3D, and the motions of |
| | Through door | from 3D | | climbing on/off and through doors are |
| | Climb on/Off | models. | | too complex to be modeled in a DHM |
| | | | | system. In DHM systems, these actions |
| | | | | can be assigned a time value and added |
| | | | | to the directory of actions. |
| Gaining | Light object | Available | Automatic | DHM system includes the geometry and |
| Control | Heavy Object | | determination | 3D information about the objects and |
| (G) | Bulky Object | | based on objects | tools, allowing embodiments to |
| | | | and tools' | determine the object's shape and whether |
| | | | geometry, | it is light, heavy, or bulky. |
| | | | weight, and | |
| | | | dimension | |
| | | | available in 3D. | |
| | Light object Simo. | Available | Necessary user | A DHM system simulation panel allows |
| | Light object non- | | input. | embodiments to determine whether an |
| | Simo. | | | object is carried by one or both hands |
| | | | | simultaneously and non-simultaneously. |
| | Blind accessibility | Available | Automatic | Based on the 3D-designed layout, Blind |
| | Obscured | | determination | or obscured accessibility can also be |
| | accessibility | | based on 3D- | specified in a simulated task. |
| | | | designed | |
| | | | layouts. | |
| | Disengage | Not directly | User input. | A DHM cannot define these variables |
| | Interlocked | recognizable | | because these types of postures and |
| | Collect | from 3D | | movements require a high degree of |
| | | models. | | precision and detail in the underlying |
| | | | | algorithms and data, as well as accurate |
| | | | | modeling of the complex interactions |
| | | | | between body parts and external objects; |
| | | | | actions can be assigned a time value and |
| | | | | added to the directory of actions. |
| Placement | Lay aside/Loose | Available | Automatic | DHM system includes the geometry and |
| (P) | fit | | determination | 3D information of the placement points |
| | Loose fit Blind/ | | based on the | (The endpoint of an action) and the 3D |
| | Obstructed | | geometry and | layouts and specific actions the user |
| | Double placement | | the layout of the | selects when designing a task, making it |
| | Blind/Obstructed | | placement points | possible to determine these variables. |
| | positioning | | available in 3D. | |
| | Place with | Not directly | Additional user | DHM systems cannot model variables |
| | adjustments/light | recognizable | input. | containing the application of force to |
| | pressure | from 3D | | placements and placement accuracy and |
| | positioning with | models. | | precision because they are abstract |
| | care/precision/ | | | variables that require additional |
| | heavy pressure/ | | | information beyond 3D geometric data |
| | Intermediate | | | and need to be added as new action verbs |
| | moves | | | in the directory of actions. |

While certain motion characteristics can be recognized in embodiments, e.g., in a DHM system implementing an embodiment, others can only be partially identified, and some may remain entirely inaccessible. Hereinbelow, functionality to address these gaps and undefined motion characteristics within a 3D environment are described.

### Actions

Defining the Action that best describes the simulated task is an important step in MOST analysis.

By defining the actions, embodiments can categorize the motions based on the MOST motion categories and identify the corresponding MOST sequence model for the action. Once the sequence model is defined, an embodiment defines the corresponding parameters for time analysis (identified in Table 1).

However, obtaining the proper action from DHM simulation data can pose challenges. First, there are often differences in the action verbs used in the DHM system directory of actions and the actions used in the MOST language. These differences can make it difficult to select the correct action verb. Moreover, there are often actions that are included in one system, but lacking in others. To address these challenges, embodiments utilize two solutions, creating a common language between the PMTS and DHM system and expanding the DHM system's vocabulary.

### Creating a Common Language Between MOST Data Cards and DHM System Action Verbs

To estimate times, e.g., in a DHM system implementing an embodiment, using MOST, an embodiment implements a common language for the work sequences described in the MOST and the DHM system. Utilizing a common language ensures consistency of information and easy integration into time estimation decision-making systems. Without a common language, verbs with the same meanings can be interpreted differently in DHM systems, making accurate time estimation challenging. An example embodiment implements a common language by translating the varied terms used by designers and engineers (e.g., associated with a DHM system) into a format that can be used in MOST data cards.

To create a common language, an embodiment unifies synonymous verbs, establishes clear definitions for each action, and implements modified data cards that describe the actions in a task or activity. The unified language is used practically to simulate actions using DHMs and record the time it takes to complete each action.

As an example, the verb “Place” may have synonyms such as “Put” or “Position”. Moreover, different variations of the verb, like “Placement with light pressure” and “Placement with heavy pressure” could be interpreted as “Insert” and “Press” in a DHM system. To overcome these challenges and ensure accurate time estimation, an embodiment unifies the language between DHM systems (used to implement embodiments) and time systems (e.g., PMTS).

### Expanding the Action Verbs Directory

Many actions existing in MOST data cards are missing from the DHM systems' directories of actions. For instance, consider the verb “Assembly”. In MOST, applying forces with the verb “Assembly” is treated as an independent action with distinct time estimations. However, in many DHM systems, this action is typically represented as a single “Assemble” action. To rectify this, an embodiment introduces two new assembly actions, namely “Assembly with pressure” and “Assembly without pressure,” to augment a DHM system's directory of action verbs. In another example, different levels of accuracy can be added to “Placement”, such as “Placement with precision”, “Placement with adjustment”, or “Placement with care”. Thus, an embodiment adds new attributes to existing actions in a DHM system directory of action verbs to cover more MOST action verbs. Thus, in an embodiment, a DHM system directory of action verbs is expanded to account for the unique characteristics of MOST parameters.

As part of this step, a variety of action verbs that typically cannot be modeled or do not exist in DHM systems and are utilized for MOST analysis (because they are either abstract or excessively complicated to be modeled in a 3D environment, such as thinking or grasping interlocked objects) are added to the directory of actions.

A DHM system may contain several action verbs that are not found on MOST data cards. As an example, consider the action “Grinding”, which is not included in MOST data cards but can be interpreted as “Get and place a grinder” (General Move) and a series of “movements with resistance” (Controlled Move). These verbs are also translated in an embodiment and assigned time values according to MOST rules.

### Body Motions (Posture Definitions)

Another challenge in estimating the time required for simulated human work is to precisely define the postures involved in the 3D models. The existing definitions for Body motions in MOST data cards were originally developed for observational body assessment, and the existing definitions lack explicit guidelines for posture determination. Time analysts often use rough observations to estimate body motions. This can lead to inaccurate time estimates, especially for complex tasks that involve multiple body motions. For example, there is uncertainty regarding the specific body angles that definitively indicate whether a human is in a standing or bending position.

An objective of an embodiment is to establish consistent boundaries and thresholds for different body motions mentioned in Table 2, which will explicitly specify the joint angles for different motions. This allows embodiments to accurately assign the appropriate body motion index value to simulated postures in 3D.

Simulated tasks in DHM systems are typically represented in static postures. This means that an embodiment can rely on two 3D models: one model that describes the mannequin in a neutral posture and another model that describes the mannequin in a critical posture of performing an action.

One way to define body motions in static postures is by comparing the joint angles and positions of the mannequin in the two models: one at the beginning (neutral posture) and the other at the end of the simulated action. These two models are often displayed in DHM systems. A tracking system can then use this information to determine the most likely body motion that corresponds to the observed joint angles and positions.

To develop a posture tracking system, an embodiment implements a process that analyzes joint angles and positions and compares the joint angles and positions to a database of known body motions (indicated in MOST data cards, such as “Sit”, “Stand”, or “Bend”). The tracking process, according to an embodiment considers the boundaries for each motion and defines the differences in joint angles and positions between the two postures to identify the proper body motion index value.

As an example, to define the sitting posture, such a process considers the following technical parameters: Trunk position, Left leg angle, and Right leg angle. Each parameter has a mean value and allowable variance, as indicated in Table 4.

TABLE 4
Technical Parameters For Defining Sitting Postures

| | | |
|---|---|---|
| | Mean | Allowable |
| Parameter | value(degrees) | variance(degrees) |

| | | |
|---|---|---|
| Trunk position | Upright | ±20 degrees |

| | | | |
|---|---|---|---|
| Left leg angle | 90 | degrees | ±20 degrees |
| Right leg angle | 110 | degrees | ±20 degrees |

To achieve a sitting posture, according to Table 4, the trunk should be upright, with a slight forward tilt of approximately 20 degrees. The mean value for the left leg relative angle should be set at 90 degrees, with an allowable variance of 20 degrees, while the right leg should be positioned slightly forward, with an angle of approximately 110 degrees between the thigh and the shin.

If the technical parameters for the trunk, left leg, and right leg are all within their defined ranges, then the posture can be labeled as “sitting”.

The following pseudocode shows a simple process for detecting the sitting posture: Function sitting_posture_detection(Trunk_position, Left_leg_angle, Right_leg_angle):

```
If (Trunk_position >= 20 degrees forward tilt) AND
(Left_leg_angle >= 70 degrees AND Left_leg_angle <= 110 degrees) AND
(Right_leg_angle >= 90 degrees AND Right_leg_angle <= 130 degrees):
  Return “Sitting posture detected”
Else
  Return “Not in sitting posture”
```

This process takes as input the technical parameters for the positions of the trunk, left leg, and right leg, which may be determined from input data. If these parameters fall within the defined ranges, the function returns “Sitting posture detected”; otherwise, it returns “Not in sitting posture”.

This process can be extended to detect other postures by identifying their unique technical parameters and allowable ranges. The general approach of this process follows the approach of Ma et al. (2010), with modifications to accommodate various joint angle thresholds that represent different body postures.

### Action Distances

Action distance, which refers to the distance covered by a worker during specific tasks, is an important aspect of time estimation. Traditional methods involve manual recording by MOST users. However, with the use of simulation tools, embodiments can precisely calculate and visualize movements during work processes. In embodiments, the 3D models, e.g., DHM, include detailed coordinates of various body parts throughout the designed workstations.

To calculate the traveled distances in a task, an embodiment begins with the starting and ending points of the action, which are defined in a 3D environment. The Euclidean distance formula is then applied to calculate the distance traveled, based on the coordinate system of a specific reference point. For example, if we consider the center of gravity of the moving hand, object, and tools as the reference point at starting and ending points represented as (X1, Y1, Z1) and (X2, Y2, Z2) coordinates respectively, the Euclidean distance formula can be calculated as follows:

$$Distance = \sqrt{( {( X 2 - X 1 )}^{2} + {( Y 2 - Y 1 )}^{2} + {( Z 2 - Z 1 )}^{2}} \qquad ( 1 )$$

This calculated distance can then be used in the PMTS as part of the time determination.

### Accuracies

Part of the accuracies required for time analyses can be automatically derived from the 3D designed models and user inputs, including a part of gain control parameter, which can be determined by having the object's dimensions and weight, and also a part of placement parameter, that can be determined by possessing the 3D information of the placement points (The place where an action ends), as detailed in Table 3. However, similar to actions, deriving all the accuracies directly from simulation input data poses challenges, making the accurate assessment of accuracies difficult. Therefore, according to an embodiment, part of accuracies is incorporated as manual inputs during the modeling process in a DHM system implementing an embodiment.

To illustrate, a DHM system cannot attain Gain control accuracies such as Disengage, Interlocked, and Collect due to their complex nature, which requires precise algorithms, detailed data, and accurate modeling of complex interactions between body parts and external objects. However, in an embodiment, these actions are assigned time values and included in the action directory of the DHM system, thereby contributing to the expansion of DHM vocabulary, as described hereinabove in relation to the Actions description.

Similarly, a DHM system cannot typically model variables related to force application, placement accuracy, and precision, such as Place with precision/care/adjustments/light pressure/heavy pressure, as these are abstract variables that require supplementary information beyond 3D geometric data that is received as input data. Consequently, according to an embodiment, such variables are introduced as new action verbs in the action directory and the user can select them during the modeling process.

### Controlled and Tool Use Moves

Existing DHM systems, such as those that may be utilized to implement embodiments, cannot currently provide the details needed to define the parameters associated with controlled and tool-use moves. Therefore, in an embodiment, users provide this information in an extension panel when creating 3D models. This extension panel can include the following: (1) If the controlled move involves interaction with a machine, the user can specify the processing time; (2) The user can specify the number of steps, stages, crank revolutions, and alignment points in controlled moves, as needed; (3) The user can specify the number of finger spins, screwdriver turns, wrench strokes, hammer taps/strikes, and wrench or ratchet cranks in Fasten or Loosen actions; (4) In cases of Cut actions, the user can define the number of scissors cuts or knife slices; (5) The user can specify the area of the surface to be cleaned in Surface treatment actions, whether it is an air nozzle clean, brush clean, or cloth wipe; (6) The user can select the measuring tool and define the distance to be measured for Measurement actions; (7) The user can specify the number of digits or words written or marked in Record actions; and (8) The user can specify the number of digits or words to be read or inspected in Think actions.

Data cards, according to an embodiment, of these two motion categories, controlled and tool-use moves, are shown in Tables 5 and 6A-B. respectively.

TABLE 5
Controlled Move Data Card
BasicMOST ® System Controlled Move A B G M X I A

| | M | | X | | | | |
|---|---|---|---|---|---|---|---|
| | Move Controlled | | Process Time | | | I | |
| Index ×10 | Push/Pull/Turn | Crank | Seconds | Minutes | Hours | Alignment | Index ×10 |
| 1 | ≤12 in. (30 cm) | | .5 Sec. | .01 Min. | .0001 Hr. | 1 Point | 1 |
| | Button | | | | | | |
| | Switch | | | | | | |
| | Knob | | | | | | |
| 3 | >12 in. (30 cm) | 1 Rev. | 1.5 Sec. | .02 Min. | .0004 Hr. | 2 Points ≤4 | 3 |
| | Resistance | | | | | in. (10 cm) | |
| | Seat or Unseat | | | | | | |
| | High Control | | | | | | |
| | 2 Stages ≤24 in. (60 cm) Total | | | | | | |
| 6 | 2 Stages >24 in. (60 cm) Total | 2-3 Rev. | 2.5 Sec. | .04 Min. | .0007 Hr. | 2 Points >4 | 6 |
| | 1-2 Steps | | | | | in. (10 cm) | |
| 10 | 3-4 Stages | 4-6 Rev. | 4.5 Sec. | .07 Min. | .0012 Hr. | | 10 |
| | 3-5 Steps | | | | | | |
| 16 | 6-9 Steps | 7-11 Rev. | 7.0 Sec. | .11 Min. | .0019 Hr. | Precision | 16 |

TABLE 6A
Tool Use Data Card - Fasten or Loosen
BasicMOST ® System Tool Use A B G A B P * A B P A

| | F Fasten or L Loosen | | | | | | | | | | | |
|---|---|---|---|---|---|---|---|---|---|---|---|---|
| | Finger | Wrist Action | | | | | | | | | Power | |
| | Action | Turns | | | | | | | | | Tool | |
| | Spins | Hand, | | | | Arm Action | | | | | Screw | |
| | Fingers, | Screwdriver, | | Cranks | Taps | Turns | | | Cranks | | Diam. | |
| | Screw- | Ratchet, | Strokes | Wrench, | Hand, | | T-Wrench, | Strokes | Wrench, | Strikes | Power | |
| Index ×10 | driver | T-Wrench | Wrench | Ratchet | Hammer | Ratchet | 2-Hands | Wrench | Ratchet | Hammer | Wrench | Index ×10 |
| 1 | 1 | — | — | — | 1 | — | — | — | — | — | — | 1 |
| 3 | 2 | 1 | 1 | 1 | 3 | 1 | — | 1 | — | 1 | ¼ in. | 3 |
| | | | | | | | | | | | (6 mm) | |
| 6 | 3 | 3 | 2 | 3 | 6 | 2 | 1 | — | 1 | 3 | 1 in | 6 |
| | | | | | | | | | | | (25 mm) | |
| 10 | 8 | 5 | 3 | 5 | 10 | 4 | — | 2 | 2 | 5 | | 10 |
| 16 | 16 | 9 | 5 | 8 | 16 | 6 | 3 | 3 | 3 | 8 | | 16 |
| 24 | 25 | 13 | 8 | 11 | 23 | 9 | 6 | 4 | 5 | 12 | | 24 |
| 32 | 35 | 17 | 10 | 15 | 30 | 12 | 8 | 6 | 6 | 16 | | 32 |
| 42 | 47 | 23 | 13 | 20 | 39 | 15 | 11 | 8 | 8 | 21 | | 42 |
| 54 | 61 | 29 | 17 | 25 | 50 | 20 | 15 | 10 | 11 | 27 | | 54 |

TABLE 6B
Tool Use Data Card - Cut, Surface Treat, Measure, Record, Think
BasicMOST ® System Tool Use A B G A B P * A B P A

| | | | | | S | | | |
|---|---|---|---|---|---|---|---|---|
| | | | | | Surface Treat | | | |
| | C | | | | Air- | Brush- | | M |
| | Cut | | | | Clean | Clean | Wipe | Measure |
| | Cutoff | | Cut | Slice | Nozzle | Brush | Cloth | Measure |
| | Pliers | | Scissors | Knife | sq. ft. | sq. ft. | sq. ft. | Measuring |
| Index ×10 | Wire | Secure | Cuts | Slices | (0.1 m²) | (0.1 m²) | (0.1 m²) | Tool |
| 1 | | Grip | 1 | — | — | — | — | |
| 3 | Soft | | 2 | 1 | — | — | ½ | |
| 6 | Medium | Twist | 4 | — | 1 | 1 | — | |
| | | Form Loop | | | Spot | | | |
| | | | | | Cavity | | | |
| 10 | Hard | | 7 | 3 | — | — | 1 | Profile Gauge |
| 16 | | Secure | 11 | 4 | 3 | 2 | 2 | Fixed Scale |
| | | Cotter Pin | | | | | | Caliper ≤12 in. (30 cm) |
| 24 | | | 15 | 6 | 4 | 3 | — | Feeler Gauge |
| 32 | | | 20 | 9 | 7 | 5 | 5 | Steel Tape ≤6 ft. (2 m) |
| | | | | | | | | Depth Micrometer |
| 42 | | | 27 | 11 | 10 | 7 | 7 | OD-Micrometer ≤4 |
| | | | | | | | | in. (10 cm) |
| 54 | | | 33 | | | | | ID-Micrometer ≤4 |
| | | | | | | | | in. (10 cm) |

| | | | | T | | | |
|---|---|---|---|---|---|---|---|
| | | | | Think | | | |
| | R | | | | Read | | |
| | Record | | | Inspect | Eyes | | |
| | Write | | Mark | Eyes/ | Digits, | | |
| | Pencil/Pen | | Marker | Fingers | Single | Text of | |
| Index ×10 | Digits | Words | Digits | Points | Words | Words | Index ×10 |
| 1 | 1 | — | Check | 1 | 1 | 3 | 1 |
| | | | Mark | | | | |
| 3 | 2 | — | 1 | 3 | 3 | 8 | 3 |
| | | | Scribe | | Gauge | | |
| | | | Line | | | | |
| 6 | 4 | 1 | 2 | 5 | 6 | 15 | 6 |
| | | | | Feel for | Scale Value | | |
| | | | | Heat | Date or Time | | |
| 10 | 6 | — | 3 | 9 | 12 | 24 | 10 |
| | | | | Feel for | Vernier Scale | | |
| | | | | Defect | | | |
| 16 | 9 | 2 | 5 | 14 | | 38 | 16 |
| | Signature or | | | | | | |
| | Date | | | | Table Value | | |
| 24 | 13 | 3 | 7 | 19 | | 54 | 24 |
| 32 | 18 | 4 | 5 | 26 | | 72 | 32 |
| 42 | 23 | 10 | 13 | 34 | | 94 | 42 |
| 54 | 29 | 7 | 16 | 42 | | 119 | 54 |

### Example of MOST Estimation Within A DHM System According to Embodiment

Estimating time within a DHM system according to an embodiment encompasses the analysis of user inputs and 3D data. The techniques presented hereinabove involve gathering temporal data from user inputs and 3D data. This data contributes to shaping the decision-making system for time estimation in an embodiment. Such an embodiment analyzes the information and estimates the time required for the designed motion by following a decision tree.

This decision tree initially categorizes the actions defined by the user, facilitating the determination of the motion sequence model and parameters (i.e., codes). By analyzing the user inputs and the two 3D models associated with the motion (the model of the DHM at an initial posture in a neutral position and the model of the DHM in critical postures, i.e., performing actions), the embodiment calculates action distances, defines body motion, and establishes index values for accuracies (Gain control and Placement). In an embodiment, these values are determined based on the selected actions, characteristics of the tools and objects (such as their weights/dimensions), and the layout of the workspace. When the action involves controlled movements or tool use, the system prompts the user for additional complementary information through an extension panel. Once all the necessary parameters have been established, the MOST code is generated for the simulated task, and the corresponding task time is calculated accordingly. Table 7 provides an example of the time analysis process for the designed action illustrated in FIG. 2 (Getting the specified bolt from the designated container).

TABLE 7
Determining MOST Code For Task Designed In FIG. 2

| MOST Building | | |
|---|---|---|
| block elements | Processing | Output |
| Motion category | The “GET” motion falls under the | The MOST sequence model for |
| | “General move” category, determined | a general move is “ABGABPA,” |
| | based on the classification within the | encompassing the three parts of |
| | directory of action verbs. | “GET” (ABG), “Put” (ABP), |
| | | and “Return” (A). |
| Action distance(A) | The action distance is calculated | In this case, the action distance |
| | according to the workspace layout. By | is the distance between the hand |
| | knowing the coordinates of the | at the neutral posture (the |
| | mannequin in a neutral posture and the | starting point) and the container |
| | container's coordinates defined in the | within reaching distance (less |
| | DHM system panel, the action | than 60 cm), resulting in an index |
| | distance is determined. | value of 1 (A1). |
| Body Motion(B) | This parameter can be determined by | In this specific scenario, no body |
| | analyzing the neutral posture and the | motion occurs, as the container |
| | critical posture of the mannequin using | is located directly in front of the |
| | the proposed posture tracking system. | mannequin and the torso doesn't |
| | | tilt beyond the defined threshold |
| | | (The trunk position is less than |
| | | 20 degree forward tilt), resulting |
| | | in an index value of 0 (B0) |
| Gaining control(G) | The hands performing the movements, | In this case, based on the |
| | the object's and tool's weight, and its | object's dimensions and weight, |
| | dimensions are defined in the user | the index value for the “G” |
| | panel. With this information, the index | parameter is 1 (indicating a light |
| | value for the “G” parameter can be | object, G1). |
| | determined. | |
| Placement(P) | The motion solely involves getting the | The index values for the “Put” |
| | object, thus, there is no placement | parameters in this code are all 0 |
| | involved. | (A0B0P0). |
| Return(A) | This motion exclusively includes the | The index value for the “Return” |
| | “Getting” action and there is no | parameters in this code is 0 |
| | Return involved. | (A0). |
| MOST code | After determining the different motion | A1B0G1A0B0P0A0 |
| | parameters, the MOST code is | |
| | generated. | |
| MOST time | The MOST time in seconds is | (1 + 0 + 1) *10*0.036 = 0.72 sec |
| | computed by summing the index | |
| | values in the MOST code, which are | |
| | then multiplied by 10 to convert them | |
| | into TMUs (Time Measurement | |
| | Units). Finally, the TMU total is | |
| | further converted into seconds by | |
| | multiplying it by 0.036, thereby | |
| | determining the total time required to | |
| | execute the entire task. | |

As described herein, embodiments can automatically determine/define some parameters using input data while, in contrast, other parameters are determined/defined based on user input. FIGS. 3-6 are graphs 330, 440, 550, and 660 illustrating the contribution of input information for the time analysis in the General move category. Using the contributions illustrated by the graphs 330, 440, 550, and 660 results in about one-third of the input information for performing time estimation coming from CAD data, while the remaining information comes from user input, including standard inputs for simulating tasks in a DHM and complementary inputs that come from extensions and assumptions.

More specifically, graph 330 of FIG. 3 illustrates that action distance (A) 331 comes from 3D information 332.

Graph 440 illustrates that gain control 441 data, which can be one of four types, light object/light object simo 442, light object non simo 443, disengage 444, and interlocked 445, is provided via user input 446-449, respectively. According to an embodiment “simo” refers to actions performed simultaneously by different body members. For instance, an action where one hand gains control of a light object (G1), while the other hand obtains another light object (G1). The total time, then, is no more than that required to gain control of one light object. Graph 550 shows the data sources for body motion 551, which includes sit 552, stand 553, bend and arise 554, body motion with adjustment 555, climb on/off 556, and through door 557. The data for sit 552, stand 553, and bend and arise 553, is determined, e.g., automatically, from 3D information 558, 559, and 560, respectively. Meanwhile, the data for body motion with adjustment 555, climb on/off 556, and through door 557 is determined from user input 561, 562, and 563, respectively. Graph 660 shows the data sources for placement 661, which includes lay aside/loose fit 662, blind/obstructed 663, adjustment 664, light/heavy pressure 665, double placement 666, care/precision 667, and intermediate moves 668. The data for lay aside/loose fit 662, blind/obstructed 663, and double placement 666 is determined from 3D information 669, 670, and 673, respectively. The data for adjustment 664, light/heavy pressure 665, care/precision 667, and intermediate moves 668, is determined from user input 671, 672, 674, and 675, respectively.

### Case Example: Implementing Integrated Time and Ergonomic Analysis in a DHM System

Embodiments can implement a process for time estimation in a DHM system. To illustrate how time and ergonomic analysis can be performed concurrently, in an embodiment, an example is described hereinbelow. This case example showcases the seamless integration of time and ergonomic analyses in a DHM system, utilizing the EWD (Ergonomic Workplace Design) software platform.

In this illustrative example, the operation, i.e., the sequence of tasks being evaluated, comprises five successive motions that are performed for screwing a bolt in an assembly setting. This operation was defined using the input panel 790. In turn, an embodiment, e.g., the method 100, was carried out to determine the dynamic ergonomic risk of performing the operation.

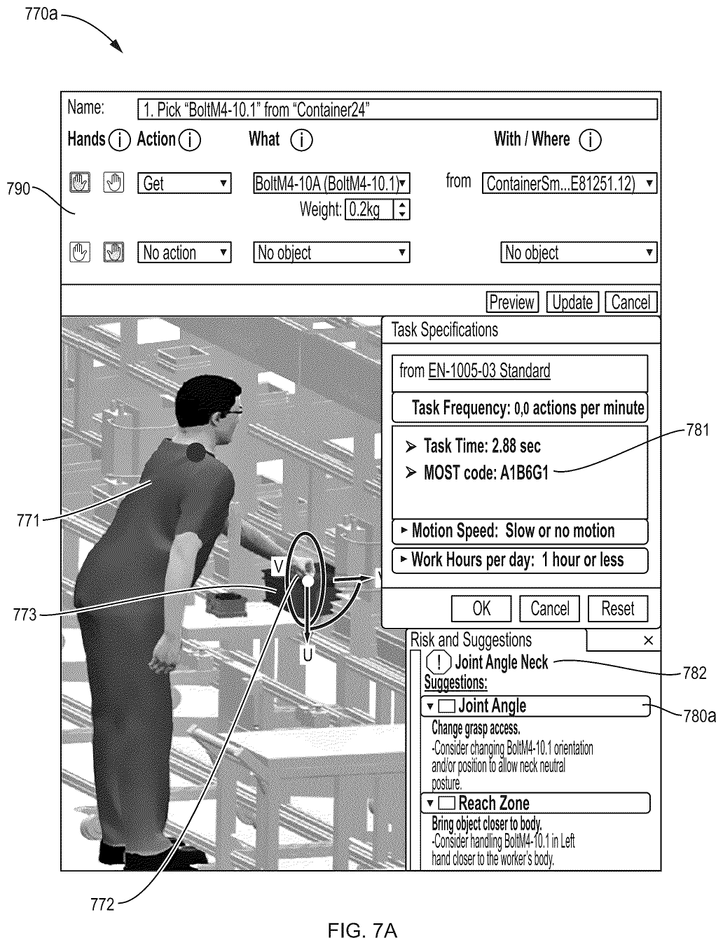

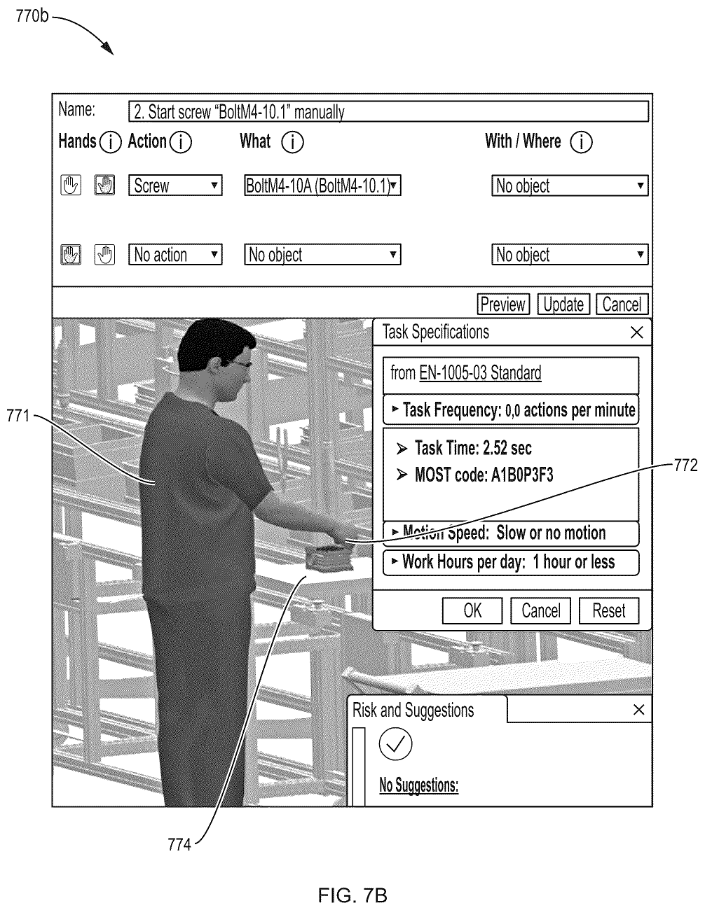

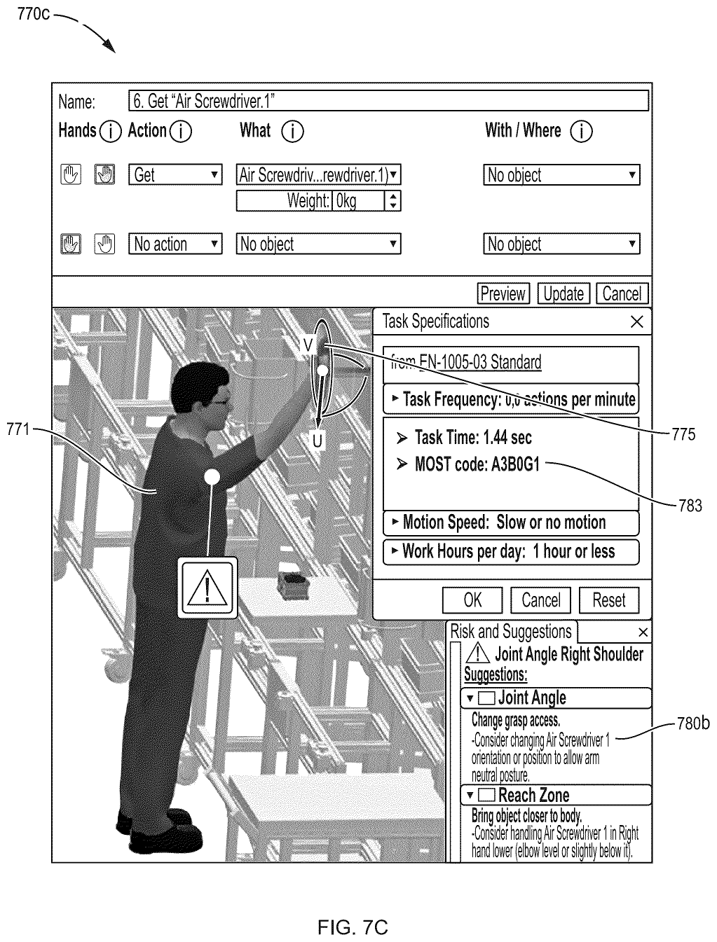

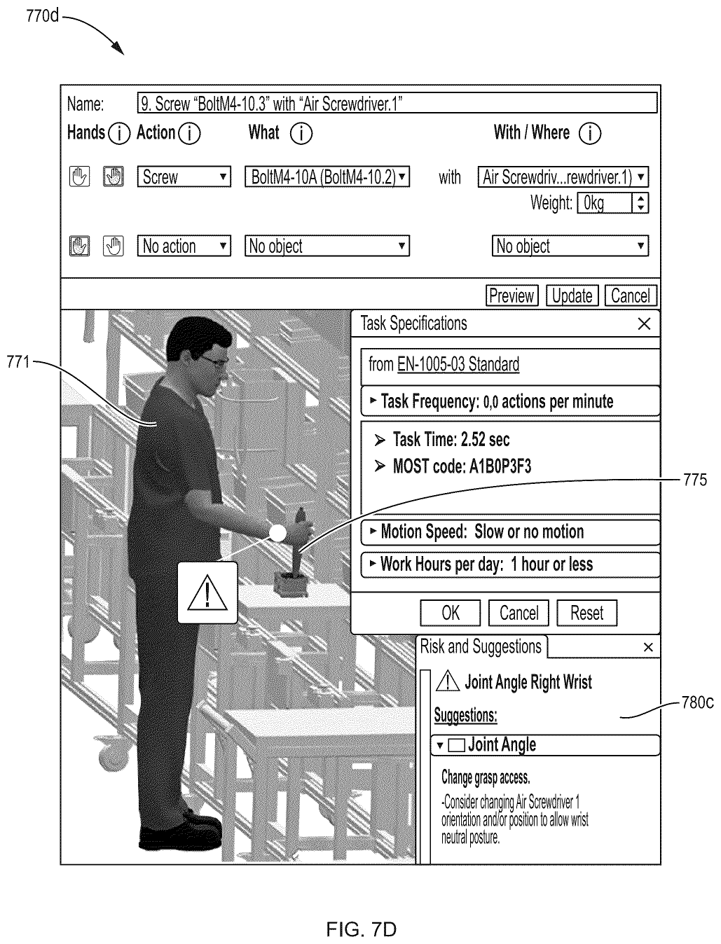

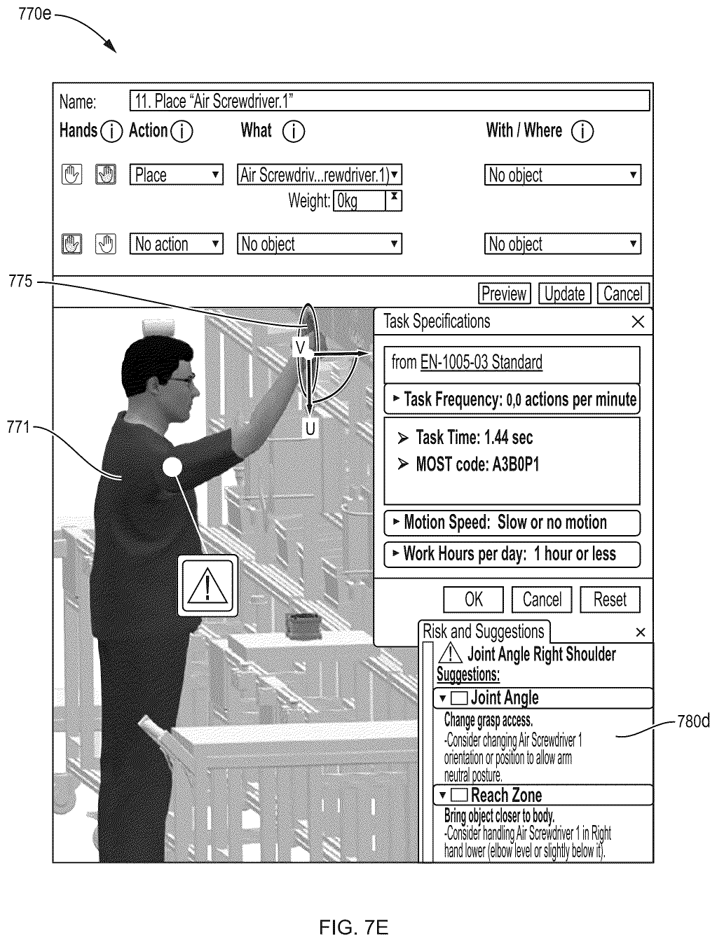

The five motions are shown in the interfaces 770a-e of FIGS. 7A-E. The operation commences with the DHM 771 grasping the specified bolt 772 from the specified storage bin 773 (illustrated in FIG. 7A), followed by the DHM 771 placing the bolt 772 into a thread on the work desk assembly 774 and manually seating the bolt on the thread (illustrated in FIG. 7B). Subsequently, the DHM 771 grasps air screwdriver 775 (illustrated in FIG. 7C) and places the air screwdriver 775 onto the bolt 772 to complete the screwing operation (illustrated in FIG. 7D). Finally, the DHM 771 returns the air screwdriver 775 to its original position, marking the end of the operation (illustrated in FIG. 7E).

FIGS. 7A-E illustrate the initial design of this operation. In a DHM system, ergonomic analysis aids designers in identifying ergonomic issues and making design adjustments as needed. For example, the interfaces in DHM systems can provide warnings and suggestions, e.g., 780a-d, that may be taken to improve ergonomics. Each designed motion in this operation contains its temporal motion characteristics. Therefore, any modifications to the design will result in changes to the parameters index values, ultimately leading to adjustments in the MOST codes and the estimated time.

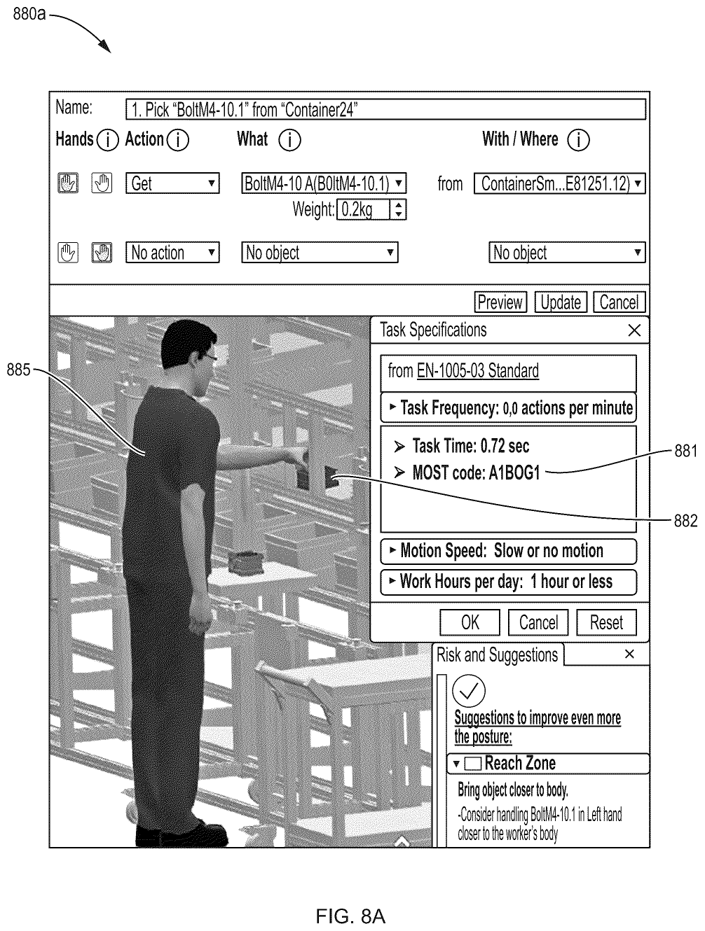

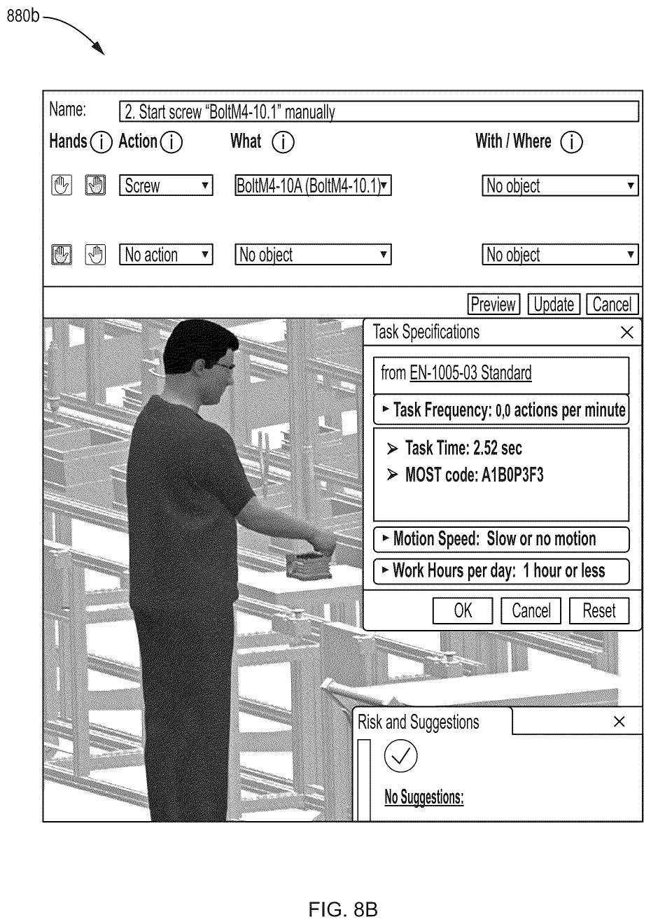

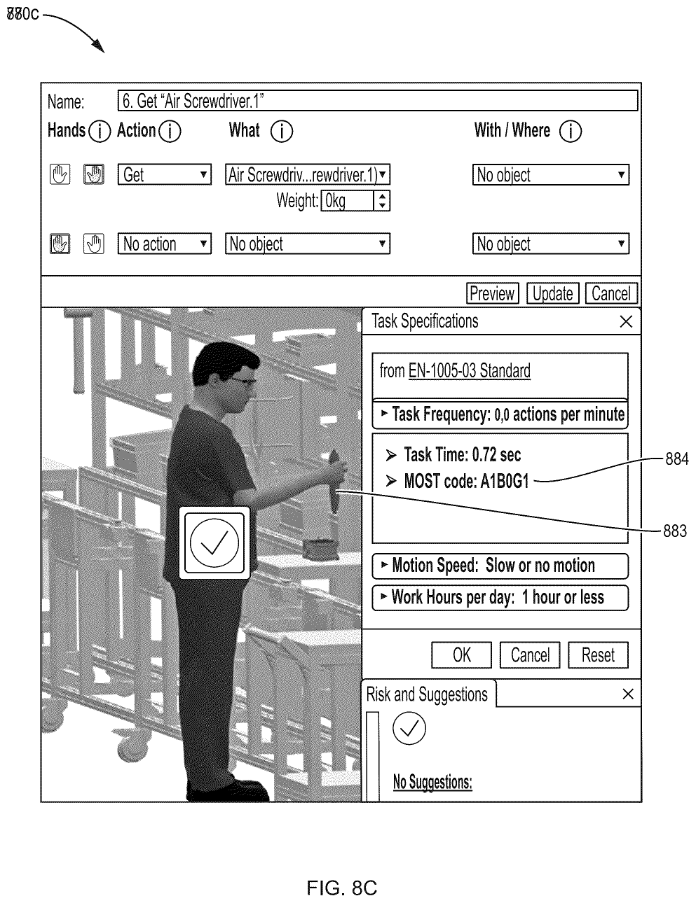

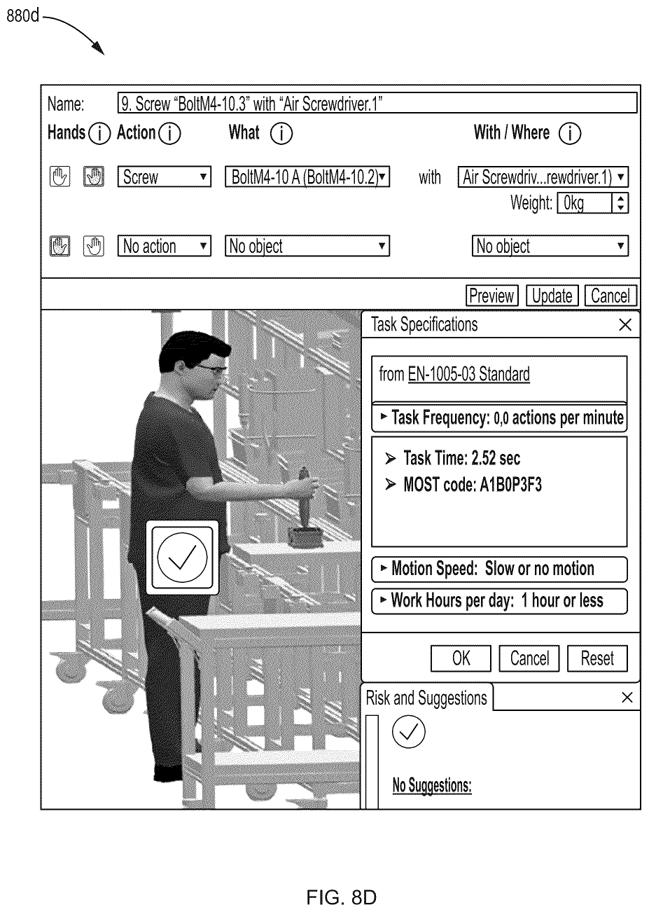

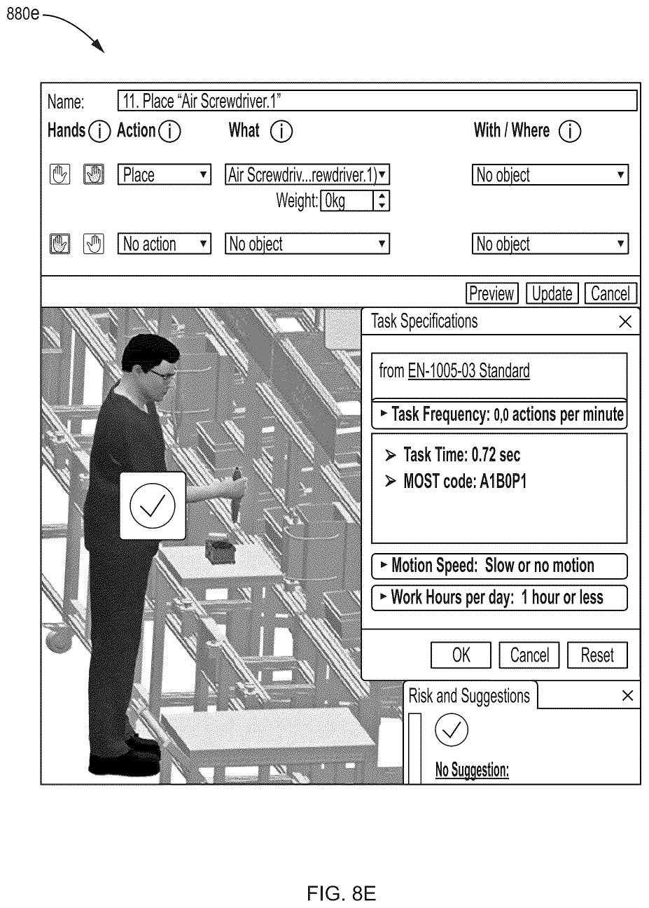

In this case, following the DHM system's recommendations (e.g., 780a-d) to address ergonomic issues in the design, resulted in reconfiguring the layout to relocate the storage bin 773 and screwdriver 775. As a result, the Action distances and the corresponding body motions were altered. A risk analysis indicated no issues with the new design (illustrated in interfaces 880a-c in FIGS. 8A-E), and the MOST codes were subsequently updated.

### Example Results

The previous section described an example of time analysis in a DHM environment. Existing methods manually conduct the time analysis after the preliminary design is completed. Manual time estimation requires expertise, and it may take a considerable amount of time for a manufacturing engineer to acquire the necessary knowledge and proficiency to effectively perform the manual time estimation.

Designing future workstations requires numerous design modifications. With each design change, time-related motion characteristics shift, and a time analyst must thoroughly reassess the entire design to identify these new time-related factors. This process is not only intricate but also time-consuming. Embodiments solve this problem by integrating time analysis within a DHM ergonomic analysis system.

As an illustration, FIG. 7A depicts a scenario in which the mannequin 771 is observed in a posture involving a reaching motion to grasp a bolt 772 from a storage bin 773, denoted by the associated MOST code “A1B6G1” 781. A concerning indicator 782 highlights a significant ergonomic risk associated with the mannequin's 771 neck posture. Consequently, an imperative need arises for design modifications aimed at mitigating this ergonomic concern. Subsequently, FIG. 8A is presented, showcasing a revised design, with the updated MOST code “A1B0G1” 881 reflecting changes in the storage bin's 882 position. These design adaptations, notably, influence the associated time estimates.

As another example, FIG. 7C, illustrates the mannequin's 771 action in grasping an air screwdriver 775, designated by the MOST code “A3B0G1” 783. To make the tool 775 accessible, the arm and trunk positions should be lifted. The ergonomic analysis identifies a moderate risk concerning shoulder posture, necessitating further design adjustments. FIG. 8C illustrates the updated design, presenting a lowered and more accessible tool 883 placement, thus mitigating the risk level. In parallel, the A index value decreases to 1, indicative of a shortened task duration in the revised MOST code “A1B0G1” 884.

Considering the constant changes in the design and the large number of operations that need to be analyzed, automated time estimation can reduce analysis time and give users, e.g., a design engineer, more flexibility.

DHM systems are increasingly being used to design and optimize human work processes. One of the key challenges in using DHM systems for this purpose is the estimation of the time required for workers to complete specific tasks. Embodiments provide a novel method for fully automated time analysis using DHM system data.

Traditionally, time analysis, e.g., MOST, is a manual process that requires a skilled time analyst to observe workers performing the tasks. This can be time-consuming and expensive, especially for tasks that are designed in 3D environments. In contrast, embodiments decrease the amount of manual work needed for the analysis of time and enable the creation of efficient and ergonomic human work processes without adding to the design workload.

An example embodiment first identifies the information needed for the analysis of a PMTS, e.g., MOST, in a 3D environment. The embodiment determines which information can be generated automatically by simulation tools and which data should be added manually during the 3D simulation of a DHM. By manually adding the information that cannot be determined automatically, it is then possible to derive a PMTS analysis.

Embodiments can be integrated into EWD (Ergonomic Workplace Design). The integration of an embodiment into EWD allows for the automatic estimation of time required for 3D-designed tasks while simultaneously conducting comprehensive ergonomic evaluations. This multifaceted analysis empowers users to visualize design effectiveness and, ultimately, results in substantial time and resource savings before building a physical prototype. Further, embodiments can be used to analyze existing physical environments, and, in turn, the physical environments can be modified in accordance with the results of embodiments to improve ergonomics in the physical environments.

Embodiments provide a framework for estimating time in a 3D environment of a DHM system using the MOST predetermined motion time system. Other PMTSs, such as MTM or MODAPTS, can also be used, as the main parameters of movement in different time systems are similar. As such, embodiments can utilize different time estimation methods and users can select a preferred PMTS.

Embodiments balance complexity and the number of assumptions so as to optimize the accuracy of time estimation. In the preproduction phase, designers have a better understanding of the design due to the availability of more details, which allows users to more accurately estimate time with fewer assumptions. Conversely, during the initial stages of the design process, DHM systems are typically used to select design concepts, and rough estimations are therefore deemed sufficient, as intricate details are not yet a priority for design engineers. Embodiments strike a balance between complexity and the number of assumptions to optimize time estimation accurately. Embodiments streamline time estimation by minimizing assumptions while maintaining user-friendly automation, ensuring accuracy despite complexity. Although direct observation may seem to offer superior accuracy due to fewer assumptions and immediate data access, embodiments show that DHM systems also yield sufficient accuracy. Specifically, during a preproduction phase, DHM systems focus on selecting design concepts where rough estimations suffice and intricate details are not the primary concern for design engineers. This balance allows DHM system users to provide estimations fulfilling the requirements of this phase.

Despite the value of automated time analysis in 3D environments, some challenges still exist. The most common way time systems are used in real-life situations is through observation, which provides an analyst with precise information on how actions are performed. However, in 3D environments, this information is often lacking. To address this challenge, embodiments can rely on a range of assumptions and supplementary sources to establish some of the PMTS parameters used for time estimation, this involves establishing specific thresholds for “Body Motion” parameter and determining thresholds for object and tool dimensions essential for precisely defining the “Gain control” parameter where specific thresholds are lacking and need to be defined based on analyst judgment in traditional time analysis. One of the advantages of using these thresholds in DHM systems is to increase the accuracy of DHM systems.

Unlike manual recordings, which may involve estimations and measurement errors, digital simulations provide a more reliable and precise measurement of Action distances, as they rely on the coordinate system to calculate the distances automatically. This eliminates the inherent uncertainties associated with human estimations.

Another challenge of estimating time in a 3D environment using static postures is the detection of body motions. Embodiments simplify this issue by proposing a posture-tracking system. The proposed method checks the mannequin's joint angles in CAD data and determines the appropriate index value for body motion.

For example, the MOST rule states that if the worker bends over 20 degrees from a neutral posture, the body motion is considered as “Bend”. In manual estimation, the analyst might doubt whether the bend is greater or lesser than 20 degrees in different cases. By automatically defining postures, the proposed method solves this problem. This is evident when comparing FIGS. 7A and 8A. The DHM 771 in FIG. 7A is noticeably bent, while the DHM 885 in FIG. 8A is only slightly bent. As soon as an embodiment checks the 3D model, such an embodiment verifies that the bending is less than 20 degrees, so it assigns B0, while, from an analyst's point of view, this might count as B3.

Because embodiments integrate time analysis methods into digital human modeling systems, embodiments allow for faster and more accurate time estimation and significantly reduce the time and effort required to estimate the duration of operations within an environment, e.g., workstation, while minimizing the potential for human error. The automated approach implemented by embodiments also provides greater flexibility for design engineers by enabling them to quickly make design adjustments without the need to re-estimate operation times.

Moreover, embodiments present a valuable resource for analyzing movements over an extended period to enhance ergonomic risk assessments and empower DHM systems to more effectively model, design, and optimize human-centric systems and products.

By integrating time analysis, embodiments can perform a comprehensive evaluation of motions and assess the sequences of events performed by workers over time. This leads to a more accurate and realistic ergonomic risk assessment. Embodiments provide a more accurate representation of human performance and safety, enabling the capture of dynamic interactions between human workers and their environment, including tools, equipment, and other workers. Through the tracking and analysis of motion patterns over time, potential sources of ergonomic risk can be more accurately identified. This information can be used to redesign workstations and equipment, adjust the workflow, and implement other interventions to reduce ergonomic risk, leading to safer and healthier work environments.

Integrating time analysis methods into DHM systems, as in embodiments, provides more advanced and accurate digital human modeling systems. Amongst other examples, embodiments can be used in a range of industries, including manufacturing, healthcare, transportation, and more. Further, embodiments can be used to design and optimize human-centric systems and products, leading to improved worker safety, health, and performance.

By implementing embodiments, users are empowered to automatically conduct time analysis, resulting in a streamlined and accelerated design process, ultimately leading to increased workplace productivity.

By automating this process in a DHM system, user can estimate time without prior knowledge while simulating a virtual task.

### Computer Support

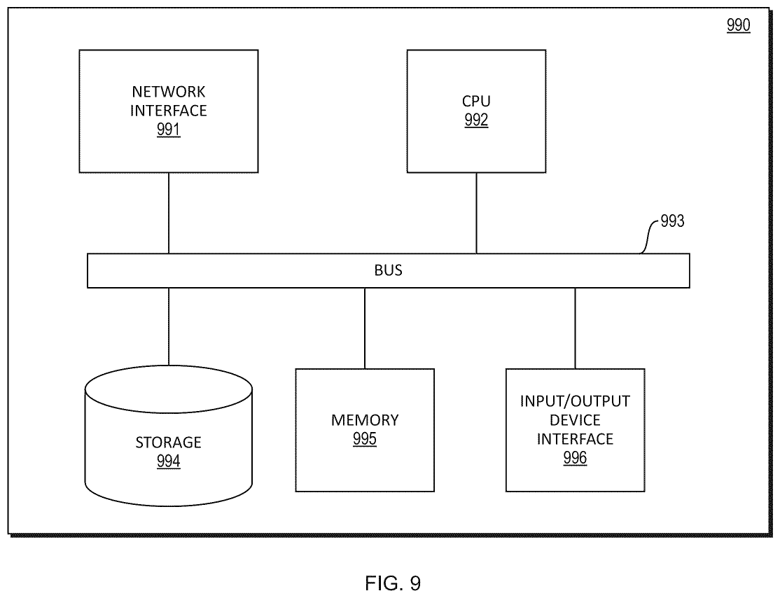

Embodiments can be implemented in the Smart Posture Engine™ (SPE™) framework inside Dassault Systèmes application “Ergonomic Workplace Design”. Moreover, embodiments may be implemented in any computer architectures known to those of skill in the art. For instance, FIG. 9 is a simplified block diagram of a computer-based system 990 that may be used to assess dynamic ergonomic risk, according to any variety of the embodiments described herein. The system 990 comprises a bus 993. The bus 993 serves as an interconnect between the various components of the system 990. Connected to the bus 993 is an input/output device interface 996 for connecting various input and output devices such as a keyboard, mouse, display, speakers, etc. to the system 990. A central processing unit (CPU) 992 is connected to the bus 993 and provides for the execution of computer instructions. Memory 995 provides volatile storage for data used for carrying out computer instructions. In particular, memory 995 and storage 994 hold computer instructions and data (databases, tables, etc.) for carrying out the methods described herein, e.g., 100 of FIG. 1. Storage 994 provides non-volatile storage for software instructions, such as an operating system (not shown). The system 990 also comprises a network interface 991 for connecting to any variety of networks known in the art, including wide area networks (WANs) and local area networks (LANs).

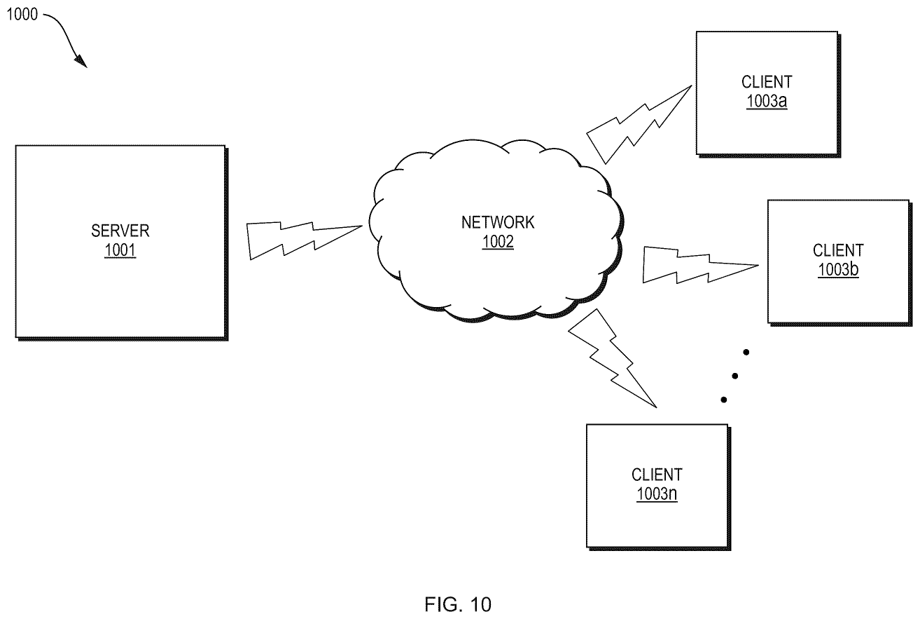

It should be understood that the example embodiments described herein may be implemented in many different ways. In some instances, the various methods and machines described herein may each be implemented by a physical, virtual, or hybrid general purpose computer, such as the computer system 990, or a computer network environment such as the computer environment 1000, described herein below in relation to FIG. 10. The computer system 990 may be transformed into the machines that execute the methods (e.g., 100) and techniques described herein, for example, by loading software instructions into either memory 995 or non-volatile storage 994 for execution by the CPU 992. One of ordinary skill in the art should further understand that the system 990 and its various components may be configured to carry out any embodiments or combination of embodiments of the present invention described herein. Further, the system 990 may implement the various embodiments described herein utilizing any combination of hardware, software, and firmware modules operatively coupled, internally, or externally, to the system 990.

FIG. 10 illustrates a computer network environment 1000 in which an embodiment of the present invention may be implemented. In the computer network environment 1000, the server 1001 is linked through the communications network 1002 to the clients 1003a-n. The environment 1000 may be used to allow the clients 1003a-n, alone or in combination with the server 1001, to execute any of the embodiments described herein. For non-limiting example, computer network environment 1000 provides cloud computing embodiments, software as a service (SAAS) embodiments, and the like.

Embodiments or aspects thereof may be implemented in the form of hardware, firmware, or software. If implemented in software, the software may be stored on any non-transient computer readable medium that is configured to enable a processor to load the software or subsets of instructions thereof. The processor then executes the instructions and is configured to operate or cause an apparatus to operate in a manner as described herein.

Further, firmware, software, routines, or instructions may be described herein as performing certain actions and/or functions of the data processors. However, it should be appreciated that such descriptions contained herein are merely for convenience and that such actions in fact result from computing devices, processors, controllers, or other devices executing the firmware, software, routines, instructions, etc.

It should be understood that the flow diagrams, block diagrams, and network diagrams may include more or fewer elements, be arranged differently, or be represented differently. But it further should be understood that certain implementations may dictate the block and network diagrams and the number of block and network diagrams illustrating the execution of the embodiments be implemented in a particular way.

Accordingly, further embodiments may also be implemented in a variety of computer architectures, physical, virtual, cloud computers, and/or some combination thereof, and thus, the data processors described herein are intended for purposes of illustration only and not as a limitation of the embodiments.

The teachings of all patents, published applications and references cited herein are incorporated by reference in their entirety.

While example embodiments have been particularly shown and described, it will be understood by those skilled in the art that various changes in form and details may be made therein without departing from the scope of the embodiments encompassed by the appended claims.

### REFERENCES

Bernard, B. P., & Putz-Anderson, V. (1997). Musculoskeletal disorders and workplace factors; a critical review of epidemiologic evidence for work-related musculoskeletal disorders of the neck, upper extremity, and low back.
Bevan, S. (2015). Economic impact of musculoskeletal disorders (MSDs) on work in Europe. Best Practice & Research Clinical Rheumatology, 29(3), 356-373.
Colombini, D. (2002). Risk Assessment and Management of Repetitive Movements and Exertions of Upper Limbs: Job Analysis, Ocra Risk Indicies, Prevention Strategies and Design Principles. Elsevier.
De Magistris, G., A. Micaelli, J. Savin, C. Gaudez, and J. Marsot. 2015. “Dynamic Digital Human Models for Ergonomic Analysis Based on Humanoid Robotics Techniques.” International Journal of the Digital Human 1 (1): 81-109.
Falck, A.- C., R. Örtengren, and D. Högberg. 2010. “The Impact of Poor Assembly Ergonomics on Product Quality: A Cost-Benefit Analysis in Car Manufacturing.” Human Factors and Ergonomics in Manufacturing & Service Industries 20 (1): 24-41. doi: 10.1002/hfm.20172.
Hales, T. R., & Bernard, B. P. (1996). Epidemiology of work-related musculoskeletal disorders. Orthopedic Clinics of North America, 27(4), 679-709.
Kazmierczak, K., W. P. Neumann, and J. Winkel. 2007. “A Case Study of Serial-Flow Car Disassembly: Ergonomics, Productivity, and Potential System Performance.” Human Factors and Ergonomics in Manufacturing 17 (4): 331-351. doi: 10.1002/hfm.20078.
Laring, J., M. Christmansson, R. Kadefors, and R. Örtengren. 2005. “ErgoSAM: A Preproduction Risk Identification Tool.” Human Factors and Ergonomics in Manufacturing 15 (3): 309-325. doi: 10.1002/hfm.20028.
Leigh, J. P. 2011. “Economic Burden of Occupational Injury and Illness in the United States.” Milbank Quarterly 89 (4): 728-772.
Ma, L., Zhang, W., Fu, H., Guo, Y., Chablat, D., Bennis, F., . . . & Fugiwara, N. (2010). A framework for interactive work design based on motion tracking, simulation, and analysis. Human Factors and Ergonomics in Manufacturing & Service Industries, 20(4), 339-352.
Neumann, W. P., and J. Dul. 2010. “Human Factors: Spanning the Gap between OM and HRM.” International Journal of Operations & Production Management 30 (9): 923-950. doi: 10.1108/01443571011075056.
Schaub, K. G., Mühlstedt, J., Illmann, B., Bauer, S., Fritzsche, L., Wagner, T., . . . & Bruder, R. (2012). Ergonomic assessment of automotive assembly tasks with digital human modeling and the ‘ergonomics assessment worksheet’ (EAWS). International Journal of Human Factors Modelling and Simulation, 3(3-4), 398-426.
Silverstein, B., Viikari-Juntura, E., & Kalat, J. (2002). Use of a prevention index to identify industries at high risk for work-related musculoskeletal disorders of the neck, back, and upper extremity in Washington state, 1990-1998. American journal of industrial medicine, 41(3), 149-169.
Wells. R., S. E. Mathiassen. L. Medbo, and J. Winkel. 2007. “Time—A Key Issue for Musculoskeletal Health and Manufacturing.” Applied Ergonomics 38 (6): 733-744. doi: 10.1016/j.apergo.2006.12.003.
Zandin, K. B. (2002). MOST work measurement systems. CRC press.

What is claimed is:

1. A computer-implemented method of assessing dynamic ergonomic risk, the method comprising, by a processor:
receiving, in memory of the processor, process planning data for an operator performing a task;
based on the received process planning data, defining parameters for a time analysis;
performing a time analysis of the operator performing the task using the defined parameters;
determining a static ergonomic risk based on the received process planning data; and
outputting an indication of dynamic ergonomic risk based on (i) results of performing the time analysis and (ii) the determined static ergonomic risk.

2. The method of claim 1 wherein the received process planning data includes a natural language statement.

3. The method of claim 2 wherein defining the parameters comprises:
performing natural language processing on the statement to extract an indicator of a movement type;
defining a category of movement based on the indicator of a movement type;
based on the defined category, identifying the parameters for the time analysis; and
setting a value of at least one parameter based on the received process planning data.

4. The method of claim 2 wherein defining the parameters comprises:
translating an element of the natural language statement to a parameter definition.

5. The method of claim 1 wherein the received process planning data includes at least one of:
physical characteristics of a workstation in a certain real-world environment at which the task is performed;
physical characteristics of the operator; and
characteristics of the task.

6. The method of claim 1 wherein receiving the process planning data comprises:
receiving a measurement from a sensor in a certain real-world environment in which the task is performed.

7. The method of claim 1 further comprising, prior to defining the parameters:
identifying the parameters by searching a look-up table based on an indication of the task in the received data, wherein the look-up table indicates the parameters as a function of the task.

8. The method of claim 1 wherein the parameters are one of: Maynard Operation Sequence Technique (MOST) parameters, Methods-Time Measurement (MTM) parameters, Modular Arrangement of Predetermined Time Standards (MODAPTS) parameters, and Work-Factor (WF) parameters.

9. The method of claim 1 wherein defining the parameters comprises:
automatically defining a first subset of the parameters based on the received process planning data; and
defining a second subset of the parameters responsive to user input.

10. The method of claim 9 wherein automatically defining the first subset of parameters comprises:
using the received process planning data, performing a computer-based simulation of a digital human model performing the task; and
defining at least one parameter, from the first subset of parameters, based on results of performing the computer-based simulation.

11. The method of claim 9 wherein automatically defining the first subset of parameters comprises at least one of:
defining a posture parameter based on body position indications from the received process planning data; and
defining a distance parameter based on an indication in the received process planning data of a start point and end point of the task.

12. The method of claim 9 wherein defining a second subset of the parameters responsive to user input comprises:
based on the received process planning data, identifying a user prompt;
providing the user prompt to a user; and
receiving the user input responsive to providing the user prompt.

13. The method of claim 1 wherein the indication of the dynamic ergonomic risk includes at least one of:
a risk type;
a risk location;
a risk level;
a suggestion to lower risk; and
time to perform the task.

14. The method of claim 13 wherein the indication of the dynamic ergonomic risk includes the suggestion, and the method further comprises:
determining the suggestion by searching a mapping between risk types, risk locations, and suggestions, wherein the determined suggestion is mapped to a given risk type and a given risk location of the dynamic ergonomic risk.

15. The method of claim 14 further comprising:
implementing the suggestion in a certain real-world environment.

16. A system for assessing dynamic ergonomic risk, the system comprising:
a processor; and
a memory with computer code instructions stored thereon, the processor and the memory, with the computer code instructions, being configured to cause the system to:
receive, in the memory, process planning data for an operator performing a task;
based on the received process planning data, define parameters for a time analysis;
perform a time analysis of the operator performing the task using the defined parameters;
determine a static ergonomic risk based on the received process planning data; and
output an indication of dynamic ergonomic risk based on (i) results of performing the time analysis and (ii) the determined static ergonomic risk.

17. The system of claim 16 wherein the received process planning data includes a natural language statement and where, in defining the parameters, the processor and the memory, with the computer code instructions, are further configured to cause the system to:
perform natural language processing on the statement to extract an indicator of a movement type;
define a category of movement based on the indicator of a movement type;
based on the defined category, identify the parameters for the time analysis; and
set a value of at least one parameter based on the received process planning data.

18. The system of claim 16 where, in defining the parameters, the processor and memory, with the computer code instructions, are configured to cause the system to:
automatically define a first subset of the parameters based on the received process planning data; and
define a second subset of the parameters responsive to user input.

19. The system of claim 16 wherein, the processor and the memory, with the computer code instructions, are further configured to cause the system to:
identify the parameters by searching a look-up table based on an indication of the task in the received data, wherein the look-up table indicates the parameters as a function of the task.

20. A non-transitory computer program product for assessing dynamic ergonomic risk, the computer program product executed by a server in communication across a network with one or more client and comprising:
a computer readable medium, the computer readable medium comprising program instructions which, when executed by a processor, causes the processor to:
receive, in memory, process planning data for an operator performing a task;
based on the received process planning data, define parameters for a time analysis;
perform a time analysis of the operator performing the task using the defined parameters;
determine a static ergonomic risk based on the received process planning data; and
output an indication of dynamic ergonomic risk based on (i) results of performing the time analysis and (ii) the determined static ergonomic risk.
